(19) United States
(12) Patent Application Publication
(10) Pub. No.: US 2023/0307157 A1
(43) Pub. Date: Sep. 28, 2023

(54) FILM FORMING DEVICE, MIST FILM FORMING DEVICE, AND METHOD FOR MANUFACTURING ELECTROCONDUCTIVE FILM

(71) Applicant: NIKON CORPORATION, Tokyo (JP)

(72) Inventors: Kotaro OKUI, Hachioji-shi (JP); Yoshiaki KITO, Kamakura-shi (JP); Takeshi SASAKI, Yokohama-shi (JP)

(73) Assignee: NIKON CORPORATION, Tokyo (JP)

(21) Appl. No.: 18/159,429

(22) Filed: Jan. 25, 2023

Related U.S. Application Data
(63) Continuation of application No. PCT/JP2021/027731, filed on Jul. 27, 2021.

(30) Foreign Application Priority Data
Jul. 27, 2020 (JP) 2020-126079

(51) Int. Cl. H01B 13/00; B05B 1/04; H01B 13/30; B05B 14/30

(52) U.S. Cl. CPC H01B 13/0026; B05B 1/044; B05B 14/30; H01B 13/30

(57) ABSTRACT

A deposition apparatus that supplies mist to a front surface of an object and deposits a film made of a material substance containing the mist on the front surface of the object, the deposition apparatus comprising a mist supplying section that includes: a mist generating section that generates the mist; an inlet port that introduces the mist generated by the mist generating section into a space; and a supply port that supplies the mist from the space to the front surface of the object, wherein the supply port is provided at a different position than the inlet port in a first direction, in a first prescribed plane that includes the supply port where the first direction and a second direction intersect and that has the mist pass therethrough.

### TECHNICAL FIELD

The present invention relates to a deposition apparatus (film forming device), a mist deposition apparatus (mist film forming device), and an electroconductive film manufacturing method for adding mist that includes fine nanoparticles (material particles) to a carrier gas, and spraying the mist and carrier gas onto a processing target substrate to deposit a film of a material substance made of the nanoparticles on the surface of the processing target substrate.

### BACKGROUND ART

In an electronic device manufacturing process, a deposition step (deposition process) is implemented to form a thin film, made of various material substances, on the surface of a substrate (processing target object) on which the electronic device is to be formed. There are various techniques for the deposition method in the deposition step, and in recent years, focus has been placed on a mist deposition method that includes spraying the surface of the substrate with mist generated from a solution containing fine particles (nanoparticles) of a material substance, reacting or evaporating a solvent component contained in the mist (solution) adhered to the substrate, and forming a thin film made of the material substance (metal material or the like) on the surface of the substrate.

WO 2012/124047 A1 discloses a mist deposition apparatus provided with a mist ejection nozzle that ejects mist, which is made up of a raw material for deposition, generated from a mist generator onto a substrate. The mist ejection nozzle of WO 2012/124047 A1 includes a body portion with a hollow portion, a mist supply port that is provided in a lateral direction of the body portion and supplies mist into the body portion, a slit-shaped ejection port that ejects the mist toward the substrate, a carrier gas supply port that is provided above the body portion and supplies a carrier gas to the inside of the body, and a shower plate that is arranged farther upward than the mist supply port inside the body and has a plurality of holes formed therein. Due to the installation of the shower plate, the hollow portion inside the body is divided into a first space connected to the carrier gas supply port and a second space connected to the mist supply port and the ejection port, and the carrier gas flows into the second space after being made uniform by passing through the shower plate, so that the mist blown onto the substrate from the ejection port becomes uniform.

In this way, in a case where the shower plate is provided in the hollow portion inside the body of the mist ejection nozzle and the distribution of the carrier gas is made uniform when flowing into the second space, it is difficult to realize good uniformity in the longitudinal direction of the slit for the concentration distribution of the mist ultimately sprayed onto the substrate if the distribution of the mist supplied from the lateral direction into the second space is not uniform in the longitudinal direction (slit longitudinal direction) of the slit-shaped ejection port.

### SUMMARY OF THE INVENTION

A first aspect of the present invention is a deposition apparatus that supplies mist to a front surface of an object and deposits a film made of a material substance containing the mist on the front surface of the object, the deposition apparatus comprising a mist supplying section that includes: a mist generating section that generates the mist; an inlet port that introduces the mist generated by the mist generating section into a space; and a supply port that supplies the mist from the space to the front surface of the object, wherein the supply port is provided at a different position than the inlet port in a first direction, in a first prescribed plane that includes the supply port where the first direction and a second direction intersect and that has the mist pass therethrough.

A second aspect of the present invention is a deposition apparatus that supplies mist contained in a carrier gas to a front surface of an object and deposits a film made of a material substance containing the mist on the front surface of the object, the deposition apparatus including a mist supplying section formed by: a moving mechanism that moves the object in a first direction that is along the front surface; a supply port that is formed in a tip portion, which faces the front surface of the object with a prescribed interval therebetween, such that the mist is ejected from the tip portion with a distribution extending in a slit shape in a second direction that intersects with the first direction; a first wall surface that is connected to one end portion of the supply port in the first direction, to fill a space that widens in the second direction with the mist from the inlet port to the supply port of the mist; and a second wall surface that is connected to the other end portion of the supply port in the first direction and has an interval with respect to the first wall surface that becomes narrower from the inlet port toward the supply port, wherein an angle of intersection between the second wall surface and an extension line of a center of an introduction vector of the mist introduced from the inlet port is set to be an acute angle.

A third aspect of the present invention is a conductive film manufacturing method comprising: a deposition step of using the deposition apparatus according to the first or second aspect of the present invention to deposit a conductive film material, which is the material substance, on the object; and a drying step of drying the object on which the deposition was performed.

A fourth aspect of the present invention is a mist deposition apparatus comprising: a mist generating section that generates mist containing a material substance; and a mist supplying section that includes an inlet port and a supply port, and supplies the mist introduced from the inlet port to a front surface of the substrate from the supply port, wherein the supply port is provided at a different position than the inlet port in a first direction, which is a direction different from the introduction direction of the mist.

A fifth aspect of the present invention is a mist deposition apparatus comprising: a mist generating section that generates mist containing a material substance; and a mist supplying section that includes an inlet port and a supply port, and supplies the mist introduced from the inlet port to a front surface of the substrate from the supply port, wherein a width of the supply port in a first direction, which is a different direction than an introduction direction of the mist, is less than a width of the inlet port in the first direction.

A sixth aspect of the present invention is a mist deposition apparatus comprising: a mist generating section that generates mist containing a material substance; and a mist supplying section that includes an inlet port and a supply port, and supplies the mist introduced from the inlet port to a front surface of the substrate from the supply port, wherein the mist supplying section includes a space that guides the mist introduced from the inlet port to the supply port, provided between the first wall surface and a second wall surface facing the first wall surface; and at least one of the first wall surface and the second wall surface is provided such that the interval between the first wall surface and the second wall surface becomes narrower from the inlet port toward the supply port.

### BRIEF DESCRIPTION OF DRAWINGS

FIG. 1 is a schematic view of the overall configuration of a mist deposition apparatus according to a first embodiment;

FIG. 2 is a perspective view of an external configuration of a nozzle unit of the mist deposition apparatus shown in FIG. 1;

FIG. 3 is a cross-sectional view of a part of the nozzle portion shown in FIG. 2 in the Yu (Y) direction, cleaved along a plane parallel to the XuZu (XZ) plane;

FIGS. 4A, 4B and 4C show several model examples obtained by simulating differences in the flow speed distribution caused by differences in the structure of the space SO inside the nozzle unit;

FIG. 5 is a graph showing the results of simulating differences in the Zu-direction flow speed of the mist gas Msf ejected from the vicinity of the Yu-direction end portion of the slit aperture AP in each of the nozzle units MN shown in FIGS. 4A to 4C;

FIG. 6 shows simulation results of the flow speed distribution in the YuZu plane of the mist gas Msf inside the space SO of the nozzle unit MN shown in FIG. 4A (FIG. 3);

FIGS. 7A, 7B and 7C show three model examples in which the shape of the space SO inside the nozzle unit MN is set such that the angle θa of the inclined inner wall surface 10A is not 30°;

FIG. 8 is a graph showing results of simulating differences in the Zu-direction flow speed of the mist gas Msf ejected from the vicinity of the Yu-direction end portion of the slit aperture portion AP of each of the nozzle units MN shown in FIGS. 7A to 7C;

FIG. 9 is a graph showing an enlarged view of a portion in the graph of the simulation results shown in FIG. 8;

FIGS. 10A, 10B, 10C and 10D are partial cross-sectional views of a modification (first modification) of the nozzle unit MN in which the angle θa of the inclined inner wall surface 10A in the nozzle unit MN is maintained while the dimensions of other portions are changed, for the simulation;

FIG. 11 is a graph showing results of a simulation of differences in the Zu-direction flow speed of the mist gas Msf for each of the nozzle units MN shown in FIGS. 10A to 10D;

FIG. 12 is a partial cross-sectional view of a modification (second modification) of the nozzle unit MN that takes into consideration the simulation results;

FIG. 13 is a partial cross-sectional view of a modification (third modification) of the nozzle unit MN that takes into consideration the simulation results;

FIG. 14 is a perspective view cleaved along a portion of a modification (fourth modification) of the nozzle unit MN that takes into consideration the simulation results;

FIG. 15 is a partial cross-sectional view, as seen in a plane parallel to the XuZu plane, of the nozzle unit MN shown in FIG. 14;

FIG. 16 shows a state in which the nozzle unit MN shown in FIGS. 14 and 15 is arranged with an incline corresponding to the incline of the substrate P;

FIG. 17 shows a detailed configuration of the nozzle unit MN and the recovery units DN1 and DN2 of the mist depositing section according to a second embodiment;

FIG. 18 is a perspective view of a partial cross section of a modification (fifth modification) of the mist depositing section of FIG. 17;

FIG. 19 is a partial cross-sectional view of another modification (sixth modification) of the configuration of the mist depositing section of FIG. 18;

FIG. 20 is a planar view, seen from the substrate P side, of a bottom surface of the mist depositing section of FIG. 19;

FIG. 21 is a perspective view of a modification (seventh modification) of the structure of the electrode-holding block member 16 shown in each of FIGS. 2, 12, and 17 to 20 above;

FIG. 22 shows a modification, seen from the -Zu side to the +Zu side, of the electrode-holding block member 16 shown in FIGS. 19 and 21;

FIGS. 23A, 23B and 23C are planar views of several modifications (eighth modification) relating to the shape and arrangement of the plurality of inlet ports formed in the block member 13 of the nozzle unit MN;

FIG. 24 shows a schematic configuration of the mist deposition apparatus according to a third embodiment;

FIG. 25 is a perspective view of a modified structure (ninth modification) of a cover portion CB applied to the mist deposition apparatus of FIG. 24 and assembled together with the nozzle unit MN, the recovery units DN1 and DN2, and the electrode-holding block member 16; and

FIG. 26 is a cross-sectional view of the cover portion CB of FIG. 25 cleaved along a plane parallel to the XuZu plane.

### DETAILED DESCRIPTION OF THE INVENTION

Preferred embodiments of a deposition apparatus, a mist deposition apparatus, and an electroconductive film manufacturing method according to the present invention will be presented and described below with reference to the accompanying drawings. The present invention is not limited to these embodiments, and various modifications and improvements could be adopted therein without departing from the essence and gist of the present invention. That is, the configurational elements mentioned below include components that could be easily envisioned by someone skilled in the art and components substantially identical thereto, and it is possible to combine the configurational elements described below as desired. Furthermore, the various configurational elements can be omitted, replaced, or changed without deviating from the scope of the present invention.

### First Embodiment

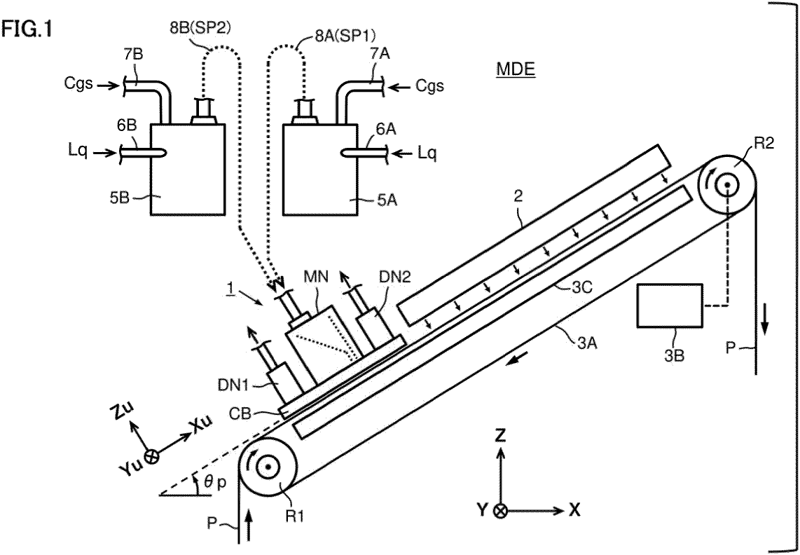

FIG. 1 shows a schematic overall configuration of a mist deposition apparatus MDE according to a first embodiment. In FIG. 1, unless otherwise specified, an XYZ orthogonal coordinate system is established in which the direction of gravity is the -Z direction. The mist deposition apparatus MDE includes a mist depositing section 1 for spraying a mist gas, which includes nanoparticles (material substance), onto a front surface of a flexible sheet substrate P (also referred to simply as a substrate P) serving as a processing target substrate (object); a drying unit 2 for drying the front surface of the substrate P on which the mist has been sprayed; an endless belt 3A for transporting the substrate P in the Xu direction (transport direction) while supporting the substrate P in a manner to be flat in a longitudinal direction (Xu direction); rotating rollers R1 and R2 around which the endless belt 3A is wound; a rotational driving section (including a motor and decelerator) 3B that rotates the rotating roller R2 at a certain speed; and a support stage 3C that supports, in a flat state, a back surface side of a flat portion of the endless belt 3A that supports the substrate P. Furthermore, the structure including at least the endless belt 3A, the rotating rollers R1 and R2, the rotational driving section 3B, and the support stage 3C is referred to as a transporting section 3D. The Y-direction width of the endless belt 3A is set to be greater than the Y-direction width of the sheet substrate P, which is in a direction orthogonal to the longitudinal direction of the sheet substrate P, and the sheet substrate P to be transported in the longitudinal direction contacts the endless belt 3A on the rotating roller R1 side and moves away from the endless belt 3A on the rotating roller R2 side.

In the present embodiment, the flat portion of the endless belt 3A and the flat top surface of the support stage 3C are arranged to be inclined at an angle θp, such that the long sheet substrate P is transported in a state of being raised in the +Z direction to be inclined at the angle θp relative to the XY plane (horizontal plane) that is orthogonal to the direction of gravity. Due to this, the mist depositing section 1 and the drying unit 2 are also arranged to be inclined at the angle θp along the transport direction of the substrate P. For the sake of describing a detailed configuration of the mist depositing section 1 below, an XuYuZu orthogonal coordinate system is established in which the longitudinal direction that is parallel to the flat surface of the substrate P is the Xu-axis direction, the width direction that is orthogonal to the longitudinal direction of the substrate P is the Yu-axis direction (parallel to the Y axis), and a direction normal to the front surface of the substrate P is the Zu-axis direction. Accordingly, the XuYuZu orthogonal coordinate system is realized by being rotated by the angle θp around the Y axis in the XYZ orthogonal coordinate system. The angle θp is set in a range from 30 degrees to 60 degrees. In this way, the configuration for depositing mist with the substrate P in an inclined state is as disclosed in WO 2016/133131 A1, for example.

In the present embodiment, the sheet substrate P is a flexible sheet with a thickness of hundreds of micrometers to tens of micrometers and has resin such as long PET (polyethylene terephthalate), PEN (polyethylene naphthalate), or polyimide as a base material, but may be made of another material such as a metal foil sheet made by thinly rolled metal materials such as stainless steel, aluminum, brass, and copper; an ultra-thin glass sheet with a thickness of 100 µm or less to give flexibility; and a resin sheet containing cellulose nanofibers. The sheet substrate P does not necessarily need to be long, and may be a sheet substrate with standardized long-side and short-side dimensions such as A4 size, A3 size, B4 size, or B3 size, or may be a non-standard irregular sheet substrate.

As shown in FIG. 1, the mist depositing section 1 of the present embodiment includes a nozzle unit (mist supplying section) MN that ejects mist gas (carrier gas containing mist) toward the substrate P, and recovery units DN1 and DN2 that are arranged respectively on the upstream side and downstream side of the nozzle unit MN in the transport direction (Xu direction) of the substrate P to recover mist gas that flows along the front surface of the substrate P without adhering to the front surface of the substrate P. Furthermore, the mist depositing section 1 is provided with a cover section CB that covers a tip portion of the nozzle unit MN that ejects the mist gas, a tip portion of each of the recovery units DN1 and DN2 that recover the mist gas using suction, and the entire top surface of the substrate P. The cover section CB functions as an air guide member that restricts the mist gas that is ejected from the nozzle unit MN and flows without adhering to the substrate P from leaking out from the space above the front surface of the substrate P and efficiently guides this mist gas to the recovery units DN1 and DN2.

The mist gas that has been generated by each of a plurality (two in this case) of atomizers 5A and 5B is supplied to the nozzle unit MN. The atomizers 5A and 5B both have the same configuration, and therefore the description will focus on the configuration of the atomizer 5A as being representative. A solution Lq, in which nanoparticles (particle size of several nanometers to hundreds of nanometers) of the material substance for deposition are dispersed with a prescribed concentration, is supplied to a container inside the atomizer (mist generating section) 5A (5B) via a pipe 6A (6B). Here, the nanoparticles are electroconductive. The solution Lq in the container is vibrated by an ultrasonic transducer, to generate mist with a particle size of approximately several micrometers to tens of micrometers from the surface of the solution Lq. The mist generated in this container is carried by a carrier gas Cgs (any one of air, O₂ gas, nitrogen gas, argon gas, carbon dioxide gas, or the like, or a mixed gas of two or more of these gases) supplied with a prescribed flow rate via a pipe 7A (7B) to become the mist gas and be guided to the nozzle unit MN via pipes 8A (SP1) and 8B (SP2).

The respective ejection ports of the plurality of pipes 8A (8B) are arranged along the Y direction (Yu direction) at the top portion of the nozzle unit MN, and each eject mist gas adjusted to have approximately the same flow rate into the internal space of the nozzle unit MN. The number of pipes 8A and 8B supplying the mist gas can be increased to be three or more, according to the Yu-direction (Y-direction) length of the nozzle unit MN. In such a case, the number of atomizers 5A and 5B is also increased to be three or more. The pipes 8A and 8B are also referred to below as pipes SPn (where n is an integer of 2 or more). By using this mist deposition apparatus, it is possible to deposit an electroconductive film on the substrate. The deposited electroconductive film may be used when manufacturing an electronic device such as a display.

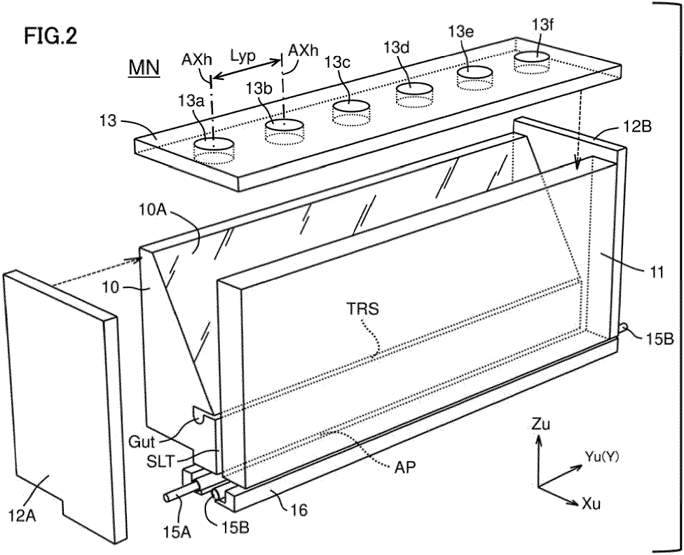

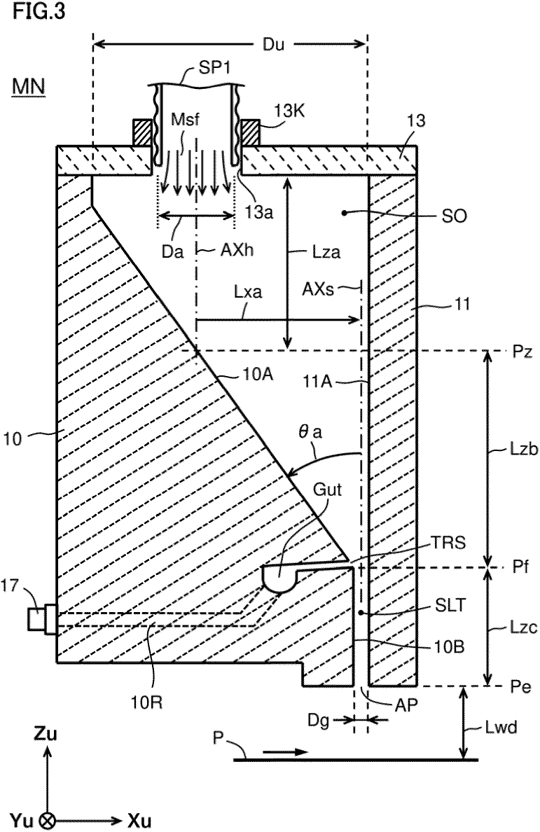

FIG. 2 is a perspective view in which an external shape of the nozzle unit MN shown in FIG. 1 is partially exploded, and FIG. 3 is a cross-sectional view obtained by cleaving a portion of the nozzle unit MN of FIG. 2 along a plane parallel to the XuZu plane in the XuYuZu coordinate system. As shown in FIGS. 2 and 3, the nozzle unit MN is formed by a block member 10 that is long in the Yu direction and whose cross-sectional shape in the XuZu plane is roughly trapezoidal; a block member 11 that is arranged facing the block member 10 in the Xu direction, is long in the Yu direction, and whose cross-sectional shape in the XuZu plane is a rectangle that is long and thin in the Zu direction; rectangular block members 12A and 12B that cover the respective Yu-direction end portions of the block members 10 and 11; and a block member (ceiling board) 13 shaped as a board parallel to the XuYu plane and covering the Zu-direction top end portion of each of the block members 10, 11, 12A, and 12B. Due to this, the overall nozzle unit MN is formed with a prismatic shape extending in the Yu direction, and at the Zu-direction bottom end portions of the block members 10 and 11, a slot portion SLT that extends in the Yu direction to uniformly distribute the mist gas in a slit shape in the Yu direction and a slit aperture portion (supply port) AP that extends linearly in the Yu direction to eject the mist gas toward the substrate P are formed. Furthermore, the plane containing the slit aperture portion AP is a first prescribed plane, and the plane containing the block member 13 is a second prescribed plane.

In addition, an electrode-holding block member 16 that holds two electrode rods 15A and 15B, which extend in the Yu direction, parallel to each other with a certain interval therebetween in the Xu direction, in order to irradiate the ejected mist gas with plasma discharge, is arranged below the slit aperture portion AP at the Zu-direction bottom end portions of the block members 10 and 11. A plasma-assisted mist deposition apparatus that irradiates the mist gas with plasma is disclosed in WO 2016/133131 A1, for example. In a case where plasma assistance is not necessary, the electrode-holding block member 16 is unnecessary.

The block members 10, 11, 12A, and 12B are made of a hard synthetic resin with high insulating properties and excellent workability and moldability, such as acrylic resin (polymethyl methacrylate: PMMA), fluorine resin (polytetrafluoroethylene: PTFE), thermoplastic polycarbonate, or a glass material such as quartz, for example. However, if plasma assistance is not to be performed, the material of the block members 10, 11, 12A, and 12B may be a metal material such as stainless steel. Furthermore, the block member 13 serving as the ceiling board is made of the synthetic resin described above, plastic, a glass material, or a metal material, and six circular inlet ports 13a to 13f are formed in the block member 13 at prescribed intervals in the Yu direction and connected respectively to the plurality of pipes SPn (here, n=6) shown in FIG. 1. The block members 10, 11, 12A, 12B, and 13 are each secured by a screw or adhesive, as shown in FIGS. 2 and 3. In the case of the nozzle unit MN shown in FIG. 2, since six pipes SP1 to SP6 are connected, six of the atomizers 5A, 5B, etc. shown in FIG. 1 are also prepared.

FIG. 3 is a cross-sectional view obtained by cleaving the block members 10, 11, and 13 of the nozzle unit MN with a plane (XuZu plane) orthogonal to the Yu axis, through the Yu-direction center of the circular inlet port 13a shown in FIG. 2, and the electrode rods 15A and 15B used for plasma discharge and the electrode-holding block member 16 are not shown in the drawing. The pipe SP1 is attached via a fastening portion 13 K to the inlet port 13a that ejects the mist gas (carrier gas Cgs containing the mist) Msf. Here, the diameter of the inlet port 13a in the XuYu plane is Da, and the center line parallel to the Zu axis and passing through the center point of the circular shape of the inlet port 13a is AXh.

As shown in FIG. 3, the block member 11 has an inner wall surface (vertical inner wall surface) 11A that is parallel to the YuZu plane, from the block member 13 to a bottom end surface Pe where the slit aperture portion AP is formed at the -Zu-direction bottom end portion of the block member 11. As shown in FIG. 3, the block member 10 includes an inner wall surface (inclined inner wall surface or first wall surface) 10A that is inclined at an angle θa relative to the YuZu plane, along the -Zu direction from the block member 13 side, and an inner wall surface (vertical wall surface) 10B that is parallel to and faces the flat inner wall surface (second wall surface) 11A of the block member 11, with an interval Dg in the Xu direction therebetween, and reaches the slit aperture portion AP in the bottom end surface Pe. The Yu-direction length of the slit aperture portion AP is set by the Yu-direction interval between the respective inner wall surfaces of the block members 12A and 12B shown in FIG. 2, and the inner wall surfaces 10A, 10B, and 11A each extend along the entire Yu-direction length of the slit aperture portion AP. With the configuration described above, as shown by FIG. 3 showing the inside of the nozzle unit MN, when viewed within the XuZu plane, a triangular funnel-shaped space SO surrounded by the inclined inner wall surface 10A and the vertical inner wall surface 11A and the slot portion SLT, which is a slot-shaped space surrounded by the vertical inner wall surface 10B and the vertical inner wall surface 11A, are formed.

The space SO is configured such that, when viewed in the XuZu plane, the Xu-direction interval between the inclined inner wall surface 10A and the vertical inner wall surface 11A continuously decreases from an interval Du, which is wide in the Xu direction, at the block member 13 side (top portion in the Zu direction) to a narrow interval Dg at a Zu-direction top portion position Pf of the slot portion SLT. Inside the space So, the extension of the center line AXh (parallel to the Zu axis) of the inlet port 13a intersects with the inclined inner wall surface 10A of the block member 10 at a Zu-direction height position Pz and is shifted (lateral shift) by an interval Lxa in the Xu direction relative to a center line AXs, which is parallel to the Zu axis and passes through the Xu-direction center of the slot portion SLT. Furthermore, the inlet port 13a is disposed such that, when the inlet port 13a is extended in the Zu direction (third direction) at the block member 13, this extension intersects with the inclined inner wall surface 10A. Yet further, Lza is a dimension in the Zu direction from the position of the bottom surface (inner wall surface) of the block member 13 (Zu-direction top end position of the interval Du) to a position Pz where the extension of the center line AXh intersects the inclined inner wall surface 10A, Lzb is a dimension in the Zu direction from the position Pz to the position Pf at the top portion of the slot portion SLT, and Lzc is a dimension of the slot portion SLT in the Zu direction from the position Pf to the bottom end surface Pe.

The mist gas Msf ejected into the space SO from the inlet port 13a (and in the same manner from the other inlet ports 13b to 13f) proceeds straight in the -Zu direction with an approximately uniform distribution within the diameter Da near the exit of the inlet port 13a, but this distribution gradually expands in the Xu direction and Yu direction as the mist gas Msf proceeds in the -Zu direction inside the space SO. However, the diameter Da, the interval Lxa, the dimension Lza, and the dimension Lzb are set such that almost all of the mist gas Msf ejected from the inlet ports 13a (13b to 13f) is sprayed onto the inclined inner wall surface 10A of the block member 10 and this mist gas Msf does not directly reach the top portion of the slot portion SLT at the position Pf. With the flow direction of the mist gas Msf ejected from the inlet port 13a (13b to 13f) being defined as the ejection vector, in the present embodiment, the center line of the ejection vector of the mist gas Msf matches the center line AXh of the inlet port 13a (13b to 13f). Furthermore, the interval (working distance) in the Zu direction between the bottom end surface Pe of the slit aperture portion AP and the front surface of the substrate P is Lwd.

As shown in FIGS. 2 and 3, the mist gas Msf from each of the inlet ports 13a to 13f is sprayed onto the inclined inner wall surface 10A of the block member 10 while maintaining the flow speed at the time of ejection, and therefore droplets are generated on the inclined inner wall surface 10A due to the adhesion of part of the mist contained in the mist gas Msf. These droplets gradually grow, and eventually flow downward (-Zu direction) along the inclined inner wall surface 10A due to the effect of gravity and the flow of the mist gas Msf. When a droplet flows down in this state, the droplet drips onto the substrate P from the slit aperture portion AP, and significantly disrupts the uniformity of the nanoparticle deposition realized by the mist deposition. Therefore, in the present embodiment, a slit portion (recovery portion) TRS extending in the Yu direction is formed as a trap portion, at the height of the position Pf that is the -Zu-direction termination end portion of the inclined inner wall surface 10A. A manifold portion (recovery portion) Gut extending in the Yu direction is formed behind the slit portion TRS in the Xu direction. The slit portion TRS is a recovery mechanism that recovers mist that has adhered to the inclined inner wall surface 10A and become a liquid. Droplets that have become trapped in the space of the slit portion TRS are stored in the manifold portion Gut and discharged through a flow path 10R formed in the block member 10, via a discharge port 17. Although not shown in the drawings, a pipe from a suction pump is connected to the discharge port 17.

In the present embodiment, one example of the dimensions of the space SO of the nozzle unit MN shown in FIGS. 2 and 3 is that the Yu-direction length (Yu-direction length of the slot portion SLT) is set to 30 to 35 mm, the Xu-direction interval (width) Du of the top end portion is set to approximately 35 mm, and the Zu-direction length (Lza+Lzb) from the bottom surface of the block member (ceiling board) 13 to the top end portion of the slot portion SLT is set to approximately 60 mm, the angle θa of the inclined inner wall surface 10A of the block member 10 is approximately 30 degrees (approximately 60 degrees relative to the XuYu plane), and the length of the inclined inner wall surface 10A in the XuZu plane is approximately 70 mm. Furthermore, the Xu-direction interval (width) Dg of the slot portion SLT (slit aperture portion AP) is set to 5 to 6 mm, and the Zu-direction dimension (length) Lzc of the slot portion SLT is set to approximately 15 mm here, but may be approximately 5 mm instead. Yet further, the diameter Da of each of the inlet ports 13a to 13f shown in FIG. 3 is set to approximately 13 mm, and the Xu-direction interval (dimension) Lxa between the center line AXh of each inlet port 13a to 13f and the center line AXs of the slot portion SLT is set in a range from 25 to 20 mm. Furthermore, the inlet port 13a is disposed at a different position than the slit aperture portion AP in the Xu direction. Yet further, the Xu-direction width (interval) Dg of the slit aperture portion AP is preferably set to be shorter than the Xu-direction width (interval) Da of the inlet port 13a. The Yu-direction interval Lyp (see FIG. 2) of the center line AXh of each inlet port 13a to 13f is set to approximately 50 to 60 mm, but this interval is changed according to the number of inlet ports 13a to 13f, and in a case where the number of inlet ports 13a to 13f is increased from six to eight, for example, the interval Lyp is set to be approximately 35 to 40 mm. Accordingly, in the configuration of FIG. 3, a relationship is set whereby Lxa > (Da+Dg)/2.

In the present embodiment, the structure and dimensions of the nozzle unit MN are set as described above, but to realize these settings, several different structures and dimensions were set and fluid simulations were performed in advance. Based on these, configurations in which the slot aperture is arranged directly below the mist gas inlet port (along the extension of the mist gas ejection direction), such as the nozzle unit disclosed in WO 2020/026823, for example, were investigated. In the case of such configurations, in order to improve the uniformity (evenness) of the flow speed distribution of the sprayed mist gas in the longitudinal direction of the slot aperture, the flow speed distribution of the mist gas in the longitudinal direction of the slot aperture immediately after the mist gas flows from the inlet port into the nozzle unit must be uniform. To achieve this, as disclosed in WO 2012/124047 A1, it is conceivable to provide a shower plate in which a plurality of holes are formed, but this creates a problem that pressure loss for the flow of mist gas increases and many droplets become stored in the shower plate, or a problem that turbulence is likely to occur.

Therefore, in the present embodiment, as shown in FIGS. 2 and 3, three or more of the inlet ports (13a to 13f) for the mist gas Msf are disposed along the Yu direction, and a setting is performed whereby an offset of an interval Lxa in the Xu direction is created between the center lines AXh of the inlet ports 13a to 13f and the center line AXs of the slit aperture portion AP (slot portion SLT), such that the mist gas Msf ejected from each of the inlet ports 13a to 13f does not travel directly toward the slit aperture portion AP (slot portion SLT). Furthermore, a configuration is realized by which the majority of the mist gas Msf ejected from each of the plurality of inlet ports 13a to 13f is sprayed onto the inclined inner wall surface 10A of the block member 10. Due to this, the flow speed distribution of the mist gas Msf (or the mist concentration distribution) in the longitudinal direction (Yu direction) of the slit aperture portion AP (slot portion SLT) can be made uniform, while smoothly changing the progression direction of the mist gas Msf to follow along the inclined inner wall surface 10A.

As shown in FIGS. 1 to 3 above, the mist deposition apparatus MDE, which sprays the mist gas Msf that is the carrier gas Cgs containing the mist onto the front surface of the substrate P to deposit the nanoparticles contained in the mist onto the surface of the substrate P in a thin film shape, includes a moving mechanism formed by the rotating rollers R1 and R2 and endless belt 3A that move the substrate P in the Xu direction (first direction), which is along the front surface thereof, and the nozzle unit MN formed by: the AP (slot aperture) formed on a tip portion such that the mist gas Msf from the tip portion facing the front surface of the substrate P with a prescribed interval therebetween to be ejected with a distribution extending in a slit shape in the Yu direction that intersects with the Xu direction; the inner wall surface 11A (first inner wall surface) that connects to one end portion of the slit aperture portion AP on the Xu-direction side in order to fill the inside of the space SO expanding in the Yu direction with the mist gas Msf, from the inlet ports 13a to 13f for the mist gas Msf to the slit aperture portion AP; and the inclined inner wall surface 10A (second inner wall) that is connected to the other Xu-direction end portion of the slit aperture portion AP and has an interval with respect to the inner wall surface 11A that becomes narrower from the inlet ports 13a to 13f toward the slit aperture portion AP (slot portion SLT). Furthermore, the inclination angle θa formed between the second inner wall surface and the center line AXh, which is the extension line through the center of the ejection vector of the mist gas Msf ejected from the inlet ports 13a to 13f, is set to an acute angle.

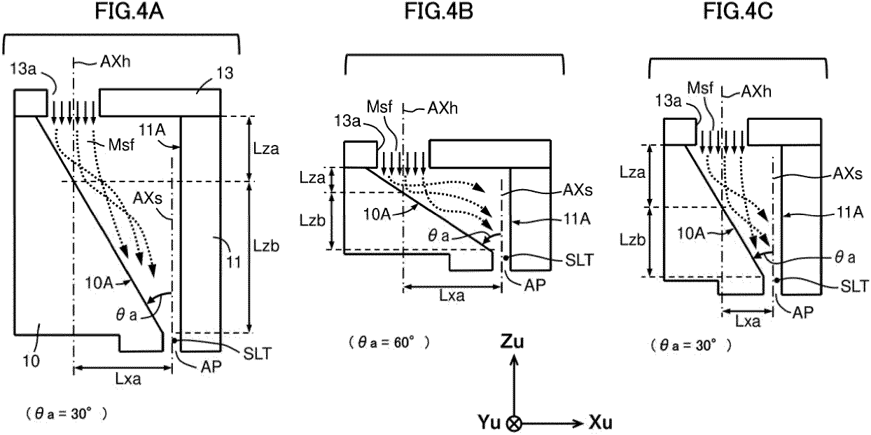

FIGS. 4A, 4B, and 4C show several model examples in which the number of inlet ports 13a to 13f, the arrangement of the inlet ports 13a to 13f in the Yu direction, and the flow speed of the mist gas Msf (carrier gas Cgs) from each of the inlet ports 13a to 13f are all the same, and differences in the flow speed distributions due to differences in the structures of the spaces SO in the nozzle unit MN were simulated. FIG. 4A shows a cross-sectional shape of a model of the nozzle unit MN having the same structure as in FIG. 3, and FIG. 4B shows a cross-sectional shape of a model in which the inclination angle θa of the inclined inner wall surface 10A of the block member 10 shown in FIG. 3 is set to 60°. Furthermore, FIG. 4C shows a cross-sectional shape of a model in which the length of the inclined inner wall surface 10A in the XuZu plane is the same as in the model of FIG. 4B, and the inclination angle θa is set to 30°. In the simulation, four of the inlet ports 13a to 13f of the nozzle unit MN were lined up in the Yu direction, and the flow speed distribution near the Yu-direction end portion of the slit aperture portion AP, which is expected to be disturbed, was investigated as the Yu-direction flow speed distribution from the slit aperture portion AP. The simulation was performed using Star-CCM+ (Registered Trademark) simulation software provided by Siemens.

In the case of the nozzle unit MN of FIG. 4B, the Xu-direction interval Lxa between the center line AXh of the inlet port 13a and the center line AXs of the slot portion SLT is set to be the same as the interval Lxa of the nozzle unit MN of FIG. 4A. Therefore, the dimension Lza and the dimension Lzb of the nozzle unit MN of FIG. 4B are both smaller than the respective dimensions of the nozzle unit MN of FIG. 4A. For the nozzle unit MN of each of FIG. 4A, FIG. 4B, and FIG. 4C, turbulence occurs in the mist gas Msf near the space where the bottom surface side of the block member (ceiling board) 13 and the vertical inner wall surface 11A of the block member 11 are joined, but the effect of degradation of the flow speed distribution of the mist gas Msf ejected from the slit aperture portion AP caused by this turbulence is lessened when the length in the XuZu plane and the dimension Lzb of the inclined inner wall surface 10A are large.

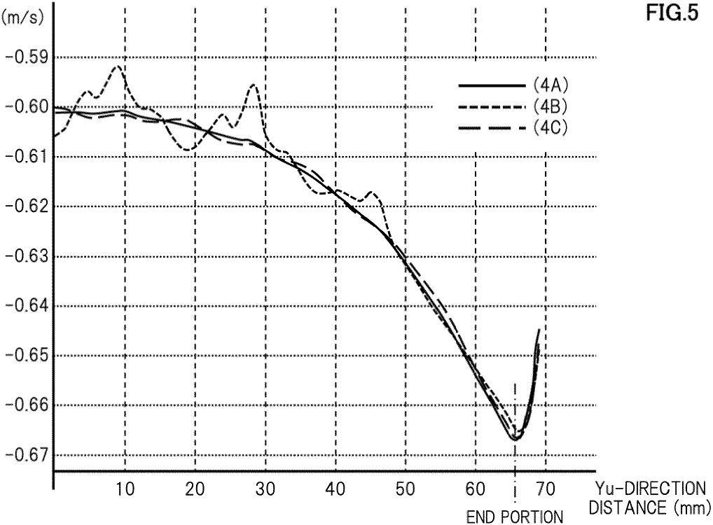

FIG. 5 is a graph showing results obtained by simulating differences in the Zu-direction flow speed of the mist gas Msf ejected from near the Yu-direction end portion of the slit aperture portion AP of the nozzle unit MN shown in each of FIG. 4A, FIG. 4B, and FIG. 4C. In FIG. 5, the horizontal axis indicates the distance in a range of approximately 70 mm near the Yu-direction end portion of the slit aperture portion AP, and the vertical axis indicates a ratio (m/s) obtained by normalizing the Zu-direction flow speed component of the mist gas Msf ejected from the slit aperture portion AP. This ratio has the Zu-direction flow speed of the mist gas Msf ejected from the inlet port 13a as a reference value, and becomes -0.5 (50% decrease) when the Zu-direction flow speed becomes half of this reference value. Accordingly, when this ratio is large (when the absolute numerical value on the vertical axis is large), this means that a component of the mist gas Msf ejected from the slit aperture portion AP directed at an incline and not parallel to the Zu axis is large compared to the component directed parallel to the Zu axis.

In FIG. 5, as shown by the characteristic (4A) indicating the case of the nozzle unit MN of FIG. 4A, the decrease (attenuation) of the flow speed of the mist gas Msf near the Yu-direction end portion of the slit aperture portion AP is entirely smooth. In the case of the nozzle unit MN of FIG. 4C, the inclination angle θa of the inclined inner wall surface 10A in the XuZu plane is the same as in the case of FIG. 4A, but since the dimension Lzb is shorter than in the case of FIG. 4A, the characteristic (4C) in FIG. 5 exhibits slight unevenness compared to the characteristic (4A). On the other hand, in the case of the nozzle unit MN of FIG. 4B in which the inclination angle of the inclined inner wall surface 10A is 60°, the dimension Lza and the dimension Lzb are both shorter than in the case of FIG. 4A and the turbulence occurring in the space SO of the nozzle unit MN becomes stronger, such that the unevenness becomes greater as shown by the characteristic (4B) of FIG. 5.

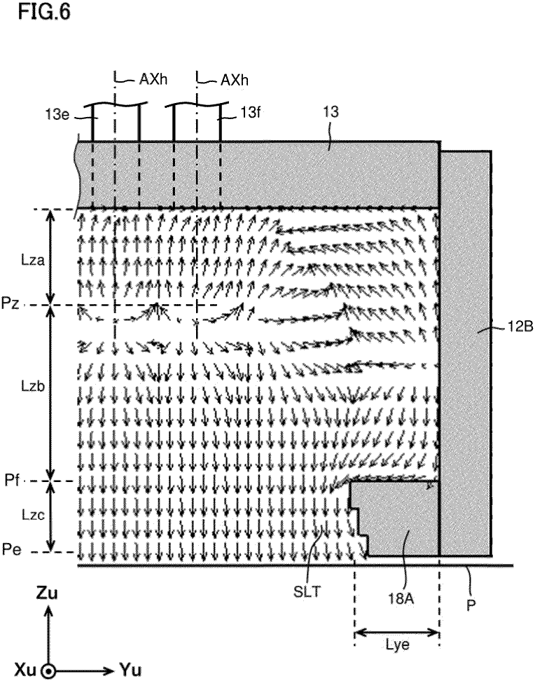

FIG. 6 shows simulation results of the flow speed distribution of the mist gas Msf in the YuZu plane inside the space SO of the nozzle unit MN shown in FIG. 4A (FIG. 3). The flow speed distribution of FIG. 6 shows only the +Yu-direction end portion side (block member 12B side) of the space SO of the nozzle unit MN, and vectors are used to express the magnitude and direction of the flow at each of many points set in a plane that is parallel to the YuZu plane and includes the center line AXs of the slot portion SLT of FIG. 4A or FIG. 3. In FIG. 6, the simulation was performed in a state where both end portions of the slot portion SLT (dimension Lzc in the Zu direction) of the nozzle unit MN are covered by the block member 18A in a range of the distance Lye (for example, 5 to 15 mm) from the block member 12B side.

As shown in FIG. 4A (FIG. 3), the mist gas Msf ejected from each of the inlet ports 13a to 13f proceeds in the -Zu direction with a uniform flow speed distribution and contacts the inclined inner wall surface 10A of the block member 10. After contacting the inclined inner wall surface 10A, the progression direction of the majority of the mist gas Msf is deflected to be inclined relative to the vertical inner wall surface 11A of the block member 11, and this mist gas Msf flows into the slot portion SLT at the position Pf in the Zu direction. Furthermore, in the vicinity of the position Pz where the center lines AXh of the inlet ports 13a to 13f intersect with the inclined inner wall surface 10A, the flow of the mist gas Msf is disturbed to also create a component directed in the ±Yu direction, the +Xu direction, or the +Zu direction. However, due to the plurality of inlet ports 13a to 13f being arranged at constant intervals in the Yu direction and to the Xu-direction width of the space SO in the nozzle unit MN (Xu-direction interval between the inclined inner wall surface 10A and the vertical inner wall surface 11A) being sequentially reduced and narrowed along the -Zu direction (toward the position Pf of the slot portion SLT), the flow speed distribution of the mist gas Msf flowing into the slot portion SLT is uniform in the Yu direction.

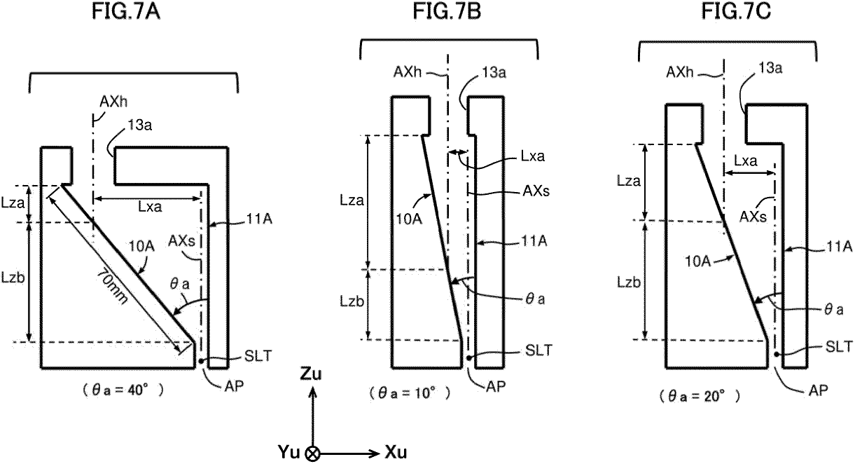

As described above, since it is confirmed that it is good for the angle θa formed by the center line AXh of each of the inlet ports 13a to 13f and the inclined inner wall surface 10A of the block member 10 to be around 30°, similar simulations where performed for several structures of the nozzle unit MN having different angles θa. For these simulations, three model examples such as shown in FIGS. 7A to 7C were set. FIG. 7A shows a model in which the length of the inclined inner wall surface 10A in the XuZu plane is approximately 70 mm, in the same manner as in FIG. 3 (FIG. 4A), and the angle θa is 40°, and FIG. 7B shows a model in which the length of the inclined inner wall surface 10A in the XuZu plane is approximately 70 mm, in the same manner as in FIG. 7A, and the angle θa is 10°. FIG. 7C shows a model in which the length of the inclined inner wall surface 10A in the XuZu plane is approximately 70 mm, in the same manner as in FIG. 7A, and the angle θa is 20°. In the case of the model example of the nozzle unit MN of FIG. 7A, the length Lza is approximately 12.5 mm, the length Lzb is approximately 47.5 mm, and the dimension Lxa is approximately 37 mm. In the case of the model example of the nozzle unit MN of FIG. 7B, the length Lza is approximately 45 mm, the length Lzb is approximately 24 mm, and the dimension Lxa is approximately 7 mm. In the case of the model example of the nozzle unit MN of FIG. 7C, the length Lza is approximately 25 mm, the length Lzb is approximately 40 mm, and the dimension Lxa is approximately 17.5 mm.

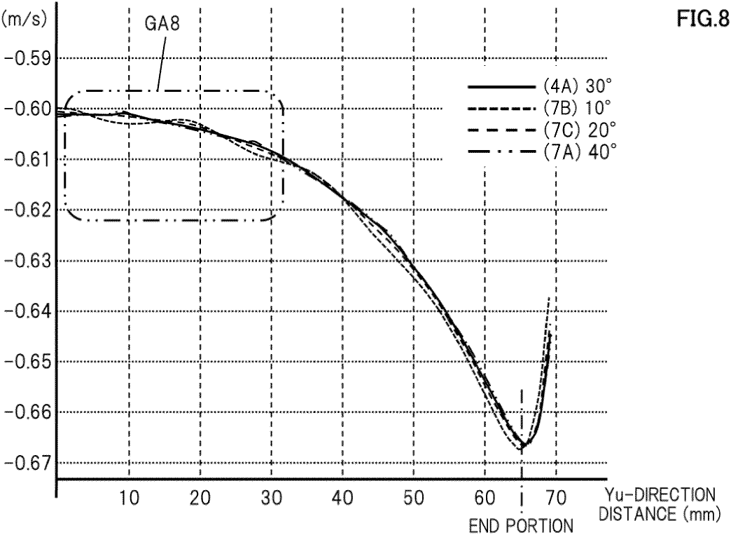

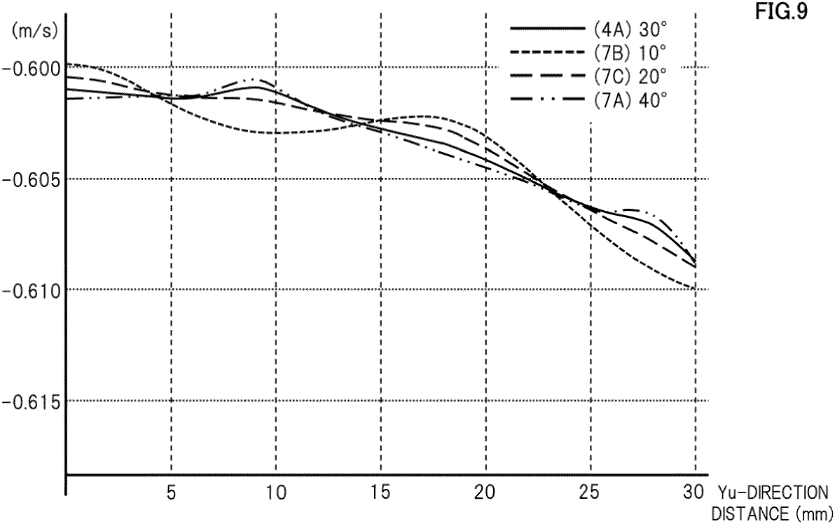

FIG. 8 is a graph showing results obtained by performing simulations in the same manner as in FIG. 5 for differences in the Zu-direction flow speed of the mist gas Msf ejected from the vicinity of the Yu-direction end portion of the slit aperture portion AP of the nozzle unit MN of FIG. 4A and the nozzle unit MN of each of FIGS. 7A, 7B, and 7C. In FIG. 8, the horizontal axis and the vertical axis are set to be the same as in FIG. 5. Furthermore, FIG. 9 is a graph showing an enlarged view of the simulation results in the range GA8 that is a distance of 0 mm to 30 mm in the Yu direction in the graph of FIG. 8.

As shown in FIG. 8, compared to the Zu-direction flow speed characteristic (4A) 30° of the mist gas Msf of the nozzle unit MN of FIG. 4A above, the Zu-direction flow speed characteristics (7A) 40°, (7B) 10°, and (7C) 20° of the mist gas Msf of the respective nozzle units MN of FIGS. 7A, 7B, and 7C do not exhibit significant changes in the overall trends. However, as shown in FIG. 9, in the range GA8 on the inner side from the Yu-direction end portions of the nozzle unit MN, the flow speed characteristics (7A) 40°, (7B) 10°, and (7C) 20° each exhibit increased unevenness (degree of change in the flow speed corresponding to the Yu-direction position) compared to the flow speed characteristic (4A) 30°. It should be noted that since the flow speed characteristic (7C) 20° tends to resemble the flow speed characteristic (4A) 30°, the angle θa of the inclined inner wall surface 10A is preferably set such that 20° < θa < 40°, and more preferably such that θa is in a range of 30°±5°.

### First Modification

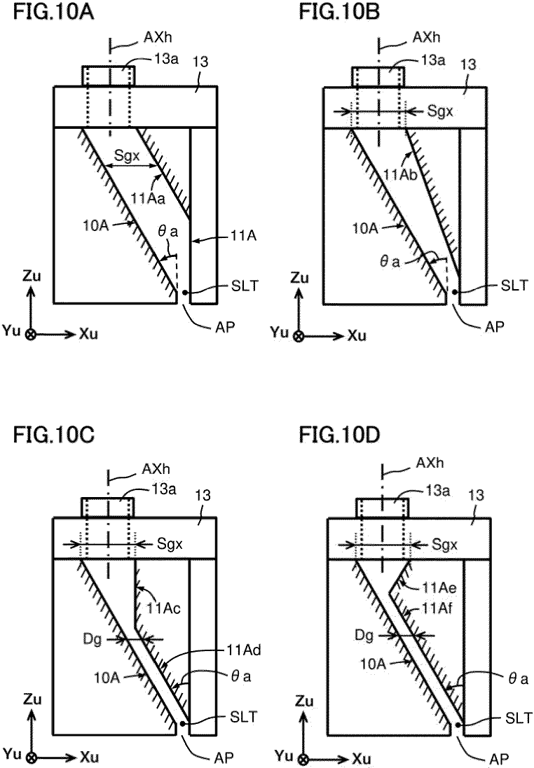

Several examples in which the configuration of the nozzle unit MN shown in FIG. 3, among the nozzle units MN described above, is used as a base and the shape of the inner wall surface on the block member 11 side facing the inclined inner wall surface 10A (angle θa = 30°) is modified are described with reference to FIGS. 10A to 10D. FIGS. 10A, 10B, 10C, and 10D each show a partial cross section, in a plane that is parallel to the XuZu plane, of the nozzle unit MN in which the inclination angle θa of the inclined inner wall surface 10A has been set to 30°.

In FIG. 10A, an inclined surface 11Aa is arranged parallel to the inclined inner wall surface 10A, separated from the inclined inner wall surface 10A in the Xu direction by a certain interval Sgx, on the inner wall surface 11A side of the block member 11 that faces the inclined inner wall surface 10A of the nozzle unit MN. The interval Sgx is provided with an Xu-direction dimension (for example, 15 to 20 mm) that is slightly larger than the Xu-direction dimension (for example, diameter of 13 mm) of the inlet port 13a formed in the block member 13 that serves as the ceiling board. The dimensions of each other portion are set to be the same as the dimensions in the nozzle unit MN described in FIG. 3 above.

In FIG. 10B, an inclined surface 11Ab, which is at an Xu-distance interval from the inclined inner wall surface 10A that gradually decreases from the bottom surface of the block member 13 serving as the ceiling board to a position near the slit aperture portion AP of the slot portion SLT, is provided on the inner wall surface 11A side of the block member 11 that faces the inclined inner wall surface 10A of the nozzle unit MN. The Xu-direction interval between the inclined inner wall surface 10A and the inclined surface 11Ab at the bottom end of the block member 13 is set to be the same as the interval Sgx in FIG. 10A, and the Xu-direction interval between the inclined inner wall surface 10A and the inclined surface 11Ab near the slit aperture portion AP is set to be approximately the interval Dg of the slot portion SLT of the nozzle unit MN shown in FIG. 3.

In FIG. 10C, an inner wall surface 11Ac parallel to the YuZu plane and an inner wall surface 11Ad parallel to the inclined inner wall surface 10A are provided continuously in the Zu direction, on the block member 11 side facing the inclined inner wall surface 10A of the nozzle unit MN. The Xu-direction interval between the inclined inner wall surface 10A and the inner wall surface 11Ac at the bottom surface of the block member 13 is set to be the same as the interval Sgx in FIG. 10A, and the Xu-direction interval between the inclined inner wall surface 10A and the inner wall surface 11Ad is set to be a constant interval approximately the same as the interval Dg of the slot portion SLT. Accordingly, the angle formed by the inner wall surface 11Ac and the inner wall surface 11Ad in the XuZu plane is set to be 180°-θa, according to the angle θa of the inclined inner wall surface 10A.

In FIG. 10D, an inner wall surface 11Ae inclined to the opposite side of the inclined inner wall surface 10A in the XuZu plane and an inner wall surface 11Af parallel to the inclined inner wall surface 10A are provided continuously in the Zu direction, on the block member 11 side facing the inclined inner wall surface 10A of the nozzle unit MN. The inclined inner wall surface 10A and the inner wall surface 11Ae are arranged symmetrically with respect to a plane that is parallel to the YuZu plane and includes the center line AXh of the inlet port 13a. Furthermore, the Xu-direction interval between the inclined inner wall surface 10A and the inner wall surface 11Ae at the bottom surface of the block member 13 is set to be the same as the interval Sgx of FIG. 10A, and the Xu-direction interval between the inclined inner wall surface 10A and the inner wall surface 11Af is set to be a constant interval approximately the same as the interval Dg of the slot portion SLT. Accordingly, the angle formed by the inner wall surface 11Ae and the inner wall surface 11Af in the XuZu plane is set to be 180°-2:8a, according to the angle θa of the inclined inner wall surface 10A.

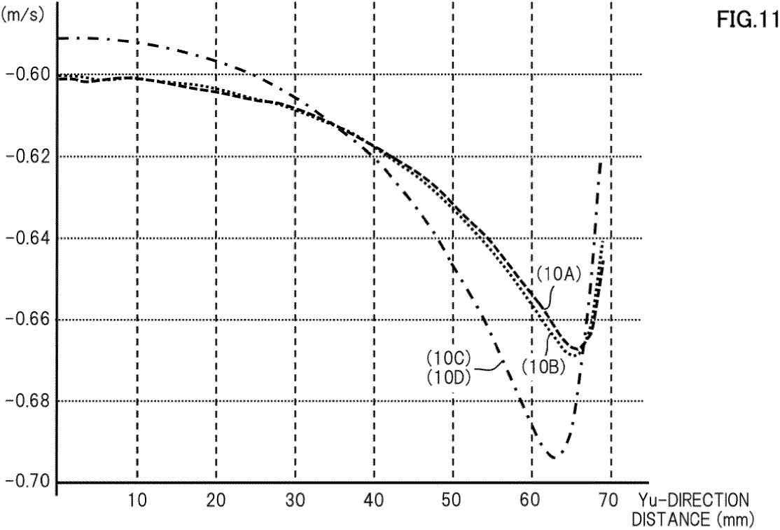

Simulations were performed, in the same manner as in FIGS. 5 and 8 above, for the nozzle units MN of each of FIGS. 10A, 10B, 10C, and 10D described above, and characteristics such as shown in FIG. 11 were obtained. In FIG. 11, the horizontal axis indicates the distance in a range of approximately 70 mm near the Yu-direction end portion of the slit aperture portion AP, and the vertical axis indicates a ratio (m/s) obtained by normalizing the Zu-direction flow speed component of the mist gas Msf ejected from the slit aperture portion AP. In the graph of FIG. 11, the characteristic (10A) shows the flow speed characteristic of the nozzle unit MN of FIG. 10A, the characteristic (10B) shows the flow speed characteristic of the nozzle unit MN of FIG. 10B, the characteristic (10C) shows the flow speed characteristic of the nozzle unit MN of FIG. 10C, and the characteristic (10D) shows the flow speed characteristic of the nozzle unit MN of FIG. 10D.

As shown by the simulation results of FIG. 11, in the cases of the nozzle units MN having the structures of FIGS. 10A and 10B, the flow speed characteristics (10A) and (10B) have approximately the same trend as the characteristic (4A) of FIG. 5, and there is little unevenness in the flow speed distributions. On the other hand, in the cases of the nozzle units MN having the structures of FIGS. 10C and 10D, the flow speed characteristics (10C) and (10D) are approximately the same as each other, but exhibit a large drop in flow speed near the end portion of the slit aperture portion AP compared to the flow speed characteristics (10A) and (10B). This is thought to occur because, in the case of the structures of FIGS. 10C and 10D, the mist gas Msf reaching the slit aperture portion AP from the inlet port 13a passes through a space that is sandwiched by the inclined inner wall surface 10A and the inner wall surface 11Ad or inner wall surface 11Af that faces the inclined inner wall surface 10A in a parallel manner with the narrow interval Dg therebetween. Based on the above, the same function and effect as realized by the MN shown in FIG. 3 can also be realized by the nozzle units MN having the modified structures shown in FIGS. 10A and 10B.

### Second Modification

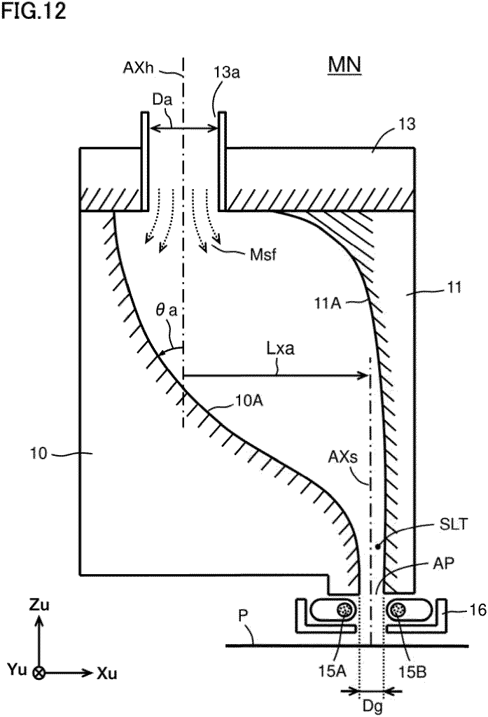

FIG. 12 shows a modification of the nozzle unit MN that takes into consideration the simulation results of each type of modification above, and shows a partial cross section thereof in a plane parallel to the XuZu plane, in the same manner as in FIG. 3 above. In FIG. 12, members and arrangements that are the same as those shown in FIG. 3 are given the same reference numerals. In the present modification, when viewed in the XuZu plane, the inclined inner wall surface 10A of the block member 10 and the inner wall surface 11A of the block member 11 form the shape of a gently curving surface. The inclined inner wall surface 10A is formed approximately parallel to the YuZu plane at a portion directly under the bottom surface of the block member 13 serving as the ceiling board and at a portion near the slit aperture portion AP (slot portion SLT), and is formed to have a gentle S-shape in the portion between these portions. In the present embodiment as well, when viewed in the XuZu plane, the angle θa formed by the center line AXh of the inlet port 13a and the inclined inner wall surface 10A is set in a range of 25° to 40°, preferably an angle of 30°, and the center line AXs of the slot portion SLT and the center line AXh of the inlet port 13a are offset from each other by an interval (dimension) Lxa in the Xu direction.

Accordingly, in the present embodiment as well, the diameter (dimension) Da of the inlet port 13a in the Xu direction, the interval Dg of the slot portion SLT (slit aperture portion AP), and the interval (dimension) Lxa are set to have a relationship of Lxa > (Da+Dg)/2, in the same manner as in the configuration of FIG. 3. In the nozzle unit MN of FIG. 12, the inner wall surface 11A of the block member 11 may be a flat surface parallel to the YuZu plane, in the same manner as in the configuration of FIG. 3.

### Third Modification

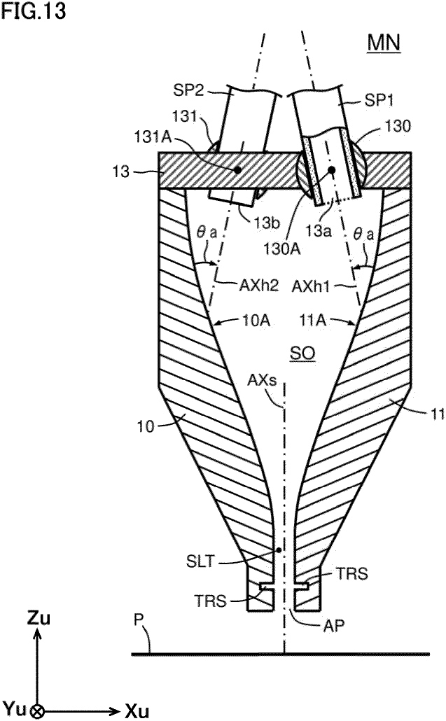

FIG. 13 shows a modification of the nozzle unit MN that takes into consideration the simulation results of each type of modification above, and shows a partial cross section thereof in a plane parallel to the XuZu plane, in the same manner as in FIG. 3 above. In FIG. 13, members and arrangements that are the same as those shown in FIG. 3 are given the same reference numerals. In the present modification, when viewed in the XuZu plane, the inclined inner wall surface 10A of the block member 10 and the inner wall surface 11A of the block member 11 are each formed as a curved surface with a gently curving S-shape, in the same manner as the inclined inner wall surface 10A in FIG. 12, and the internal space SO is formed with a funnel shape in the XuZu plane. The inclined inner wall surface 10A and the inner wall surface 11A of FIG. 13 are arranged symmetrically in the Xu direction, with respect to a plane that is parallel to the YuZu plane and includes the center line AXs of the slot portion SLT.

In the present embodiment, among the plurality of pipes SP1, SP2, etc. attached to the block member 13 serving as the ceiling board, odd-numbered pipes SP1, SP3, etc. and the even-numbered pipes SP2, SP4, etc. are arranged to be positioned at a constant interval from each other in the Xu direction. Furthermore, the tip portion (inlet port 13a side) of each odd-numbered pipe SP1, SP3, etc. is provided penetrating through a pivoting member 130, which is supported to be rotatable around an axis 130A extending in the Yu direction, and the tip portion (inlet port 13b side) of each even-numbered pipe SP2, SP4, etc. is provided penetrating through a pivoting member 131, which is supported to be rotatable around an axis 131A extending in the Yu direction. In the present embodiment, the circular ejection ports at the tips of the plurality of pipes SP1, SP2, etc. function as the inlet ports 13a, 13b, etc., and the respective center lines AXh1, AXh2, etc. of these ejection ports are inclined relative to the center line AXs of the slot portion SLT when viewed in the XuZu plane.

The extension of the center line AXh1 of the ejection port of each odd-numbered pipe SP1, SP3, etc. intersects with the inner wall surface 11A of the block member 11 at the angle θa, when viewed in the XuZu plane, and the extension of the center line AXh2 of the ejection port of each even-numbered pipe SP2, SP4, etc. intersects with the inclined inner wall surface 10A of the block member 10 at the angle θa, when viewed in the XuZu plane. This angle θa is set in a range of 25° to 40°, but in the present modification, the angle θa can be easily adjusted by the respective pivoting members 130 and 131. It should be noted that, in the present modification as well, the mist gas Msf ejected from the ejection ports of the respective odd-numbered pipes SP1, SP3, etc. and even-numbered pipes SP2, SP4, etc. is set to not travel directly toward the slot portion SLT (slit aperture portion AP).

According to the present embodiment, when variation is caused in the air volume (wind speed) of the mist gas Msf ejected into the internal space of the nozzle unit MN from each of the plurality of pipes SP1, SP2, etc., or when the overall air volume (wind speed) of the mist gas Msf ejected from each of the plurality of pipes SP1, SP2, etc. is significantly changed, it is possible to perform an adjustment, by rotating the pivoting members 130 and 131, to reduce unevenness in the Yu-direction air volume (wind speed) distribution of the mist gas Msf ejected from the slit aperture portion AP. The configuration such as shown in FIG. 13, in which the pivoting member 130 is provided to make it possible to adjust the ejection direction of the mist gas Msf from each of the pipes SP1, SP2, etc. is capable of being applied in the same manner to the nozzle unit MN of FIG. 3 above.

### Fourth Modification

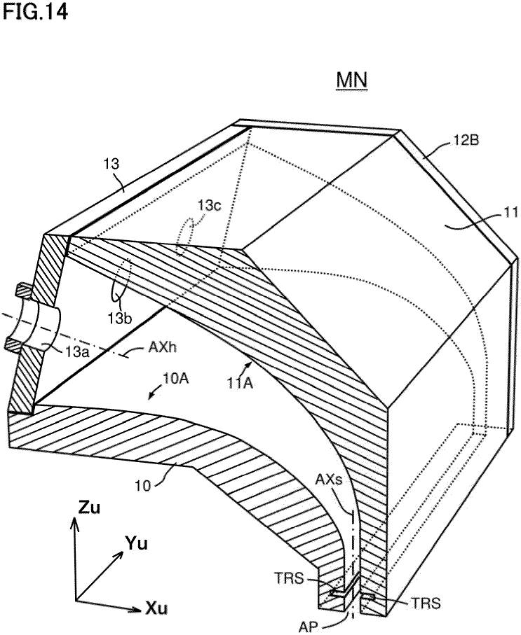

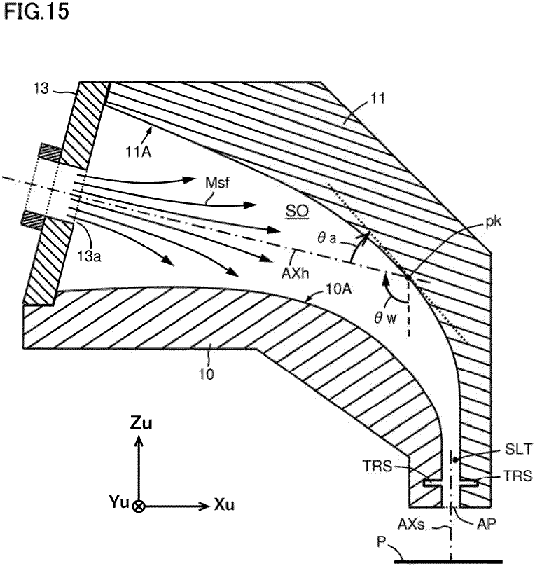

FIG. 14 shows a modification of the nozzle unit MN that takes into consideration the simulation results of each type of modification above, and is a perspective view obtained by cleaving along a plane parallel to the XuZu plane at the position of the inlet port 13a, in the same manner as in FIG. 3 above. FIG. 15 is a partial cross-sectional view of the nozzle unit MN of FIG. 14 along a plane parallel to the XuZu plane. In FIGS. 14 and 15, members, materials, and arrangements that are the same as those of the nozzle unit MN shown in FIG. 3 are given the same reference numerals, and although only three inlet ports 13a to 13c are shown as being representative of the plurality of inlet ports supplied with the mist gas Msf, the number of inlet ports may be greater than three.

In the present modification, the inner wall surface of the block members 12A and 12B (the block member 12A is not shown in FIG. 14) provided at the respective longitudinal-direction (Yu-direction) ends of the nozzle unit MN are parallel to the XuZu plane, and the inner wall surface of the block member 13 serving as the ceiling board is a flat surface slightly inclined relative to the YuZu plane. It should be noted that the inner wall surface of the block member 13 may be arranged parallel to the YuZu plane. Furthermore, in the present modification, as shown in FIG. 15, the center line AXh of the inlet port 13a (and the other inlet ports) having a circular cross section and the Xu-direction center line AXs of the slot portion SLT (slit aperture portion AP) are set to form an angle θw (obtuse angle) of 90° or more in the XuZu plane.

Furthermore, in the present modification, the shape of the space SO surrounded by the inner wall surface 10A of the block member 10 and the inner wall surface 11A of the block member 11, when viewed in the XuZu plane, is formed with a bent funnel shape obtained by bending the space SO of the nozzle unit MN shown in FIG. 13 above by an angle θw. The inner wall surface 10A of the block member 10 and the inner wall surface 11A of the block member 11 are formed tracing an alternating curve shape (curve shape in which the curvature radius transitions consecutively from large, to small, to large) within the XuZu plane. Due to this, the mist gas Msf ejected from the inlet ports 13a to 13c travels toward the slot portion SLT (slit aperture portion AP) while being constricted within the space SO in the XuZu plane. As shown in FIG. 15, in the present modification, the extension of the center line AXh of each of the inlet ports 13a to 13c intersects with the inner wall surface 11A of the block member 11, but the angle θa formed by the center line AXh and the tangent plane orthogonal to the vertical line of the inner wall surface 11A at this intersection point pk is set to be in a range of 25° to 40°. Accordingly, in the present modification, the inner wall surface 11A of the block member 11 functions as an inclined inner wall surface.

Even in a case where the space SO inside the nozzle unit MN is formed with a curved funnel shape, such as in FIGS. 14 and 15, there is a possibility of droplets, which are caused by the gathering (aggregation) of mist adhered to the inner wall surface 11A of the block member 11 or the inner wall surface 10A of the block member 10, flowing along the wall surface of the slot portion SLT to drip down onto the substrate P from the slit aperture portion AP. Therefore, a slit portion TRS for trapping the droplets is provided near the slit aperture portion AP of each of the inner wall surfaces 10A and 11A, in the same manner as in FIG. 3.

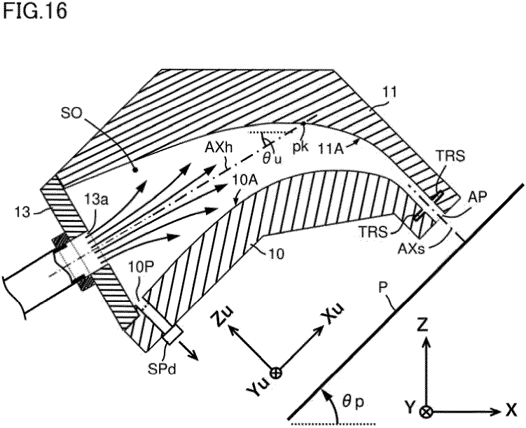

FIG. 16 shows an arrangement example of the nozzle unit MN of FIGS. 14 and 15, in a state where the front surface of the substrate P facing the slit aperture portion AP is set to be inclined by an angle θp (for example, 45°) from the XY plane in the XYZ coordinate system, in the same manner as shown in FIG. 1 above. Therefore, in FIG. 16, the XuYuZu coordinate system of the nozzle unit MN of FIGS. 14 and 15 is arranged inclined by the angle θp around the Y axis in the XYZ coordinate system. In the case of such an arrangement, the center lines AXh of the inlet ports 13a to 13c are inclined at an angle θu relative to the XY plane when viewed in the XZ plane, and this angle θu is θu = 90°-(θw-θp). As an example, in a case where the angle θw (see FIG. 15) is 105° and the angle θp is 45°, the angle θu becomes 30°. Accordingly, the center spraying vector of the mist gas Msf ejected into the space SO from each of the inlet ports 13a to 13c is directed diagonally upward when viewed in the XYZ coordinate system.

Furthermore, the junction portion where the inner wall surface 10A of the block member 10 positioned on the bottom side (-Z direction) of the space SO joins with the block member 13 serving as the ceiling board is positioned farther downward in the Z direction, and the majority of the inner wall surface 10A is inclined diagonally toward this junction portion. Similarly, the front surface portion of the inner wall surface 11A of the block member 11 that is to the block member 13 side of the intersection point pk is inclined in the -Z direction relative to the XY plane. Therefore, most of the droplets that have adhered to the inner wall surface 11A flow along the inner wall surface 11A to the block member 13 side or fall down onto the inner wall surface 10A therebelow. The portion of the inner wall surface 10A to the -X-direction side of the intersection point pk is inclined in the -Z direction toward the block member 13 side, and therefore the droplets that have fallen onto this portion from the inner wall surface 11A flow along the inner wall surface 10A to the block member 13 side.

Therefore, in the present modification, a groove 10P extending in the Y (Yu) direction to trap the droplets is formed at the junction portion where the inner wall surface of the block member 13 of the nozzle unit MN joins the inner wall surface 10A of the block member 10, and a discharge port portion SPd that discharges the droplets to the outside is formed in a portion of the inside of the groove 10P. A pipe for discharge (drainage) is connected to the discharge port portion SPd. In this way, by arranging the nozzle unit MN of the present modification inclined by the angle 8p, it is possible to recover most of the droplets that have adhered to the inner wall surfaces 10A and 11A defining the space SO inside the nozzle unit MN from the discharge port portion SPd, and to significantly decrease the droplets travelling toward the slit aperture portion AP. Even assuming that droplets travelling toward the slit aperture portion AP along the inner wall surfaces of the slot portion SLT were to occur, these droplets would be captured by the slit portion TRS arranged directly before the slit aperture portion AP.

### Second Embodiment

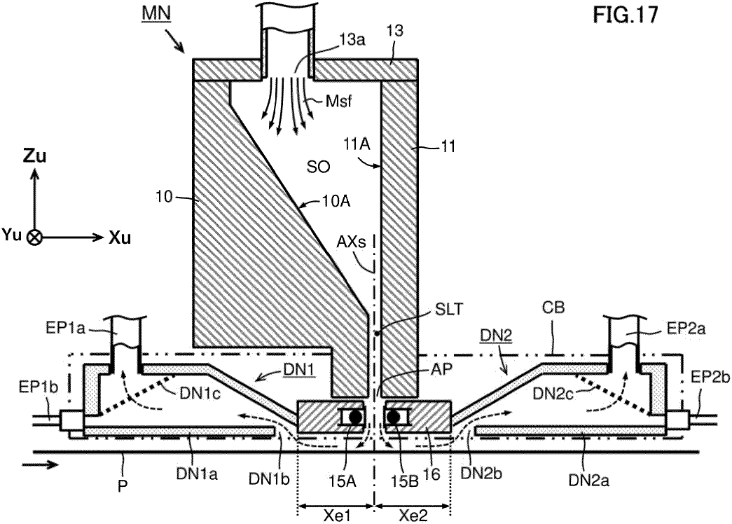

FIG. 17 shows a detailed configuration of the nozzle unit MN, recovery units DN1 and DN2, and the cover portion CB of the mist deposition apparatus MDE shown in FIG. 1, and is a partial cross-sectional view thereof obtained by cleaving along a plane parallel to the XuZu plane. In FIG. 17, the configuration of the nozzle unit MN is the same as in FIG. 3 above, but may instead be any one of the configurations shown in FIGS. 10A, 10B, and 12 to 14. Furthermore, the electrode-holding block member 16 that supports the electrode rods 15A and 15B for plasma assistance with a prescribed Xu-direction interval therebetween is provided between the substrate P and the slit aperture portion AP of the nozzle unit MN shown in FIG. 17. An interval of approximately several millimeters is set between the front surface of the substrate P and the bottom surface of the electrode-holding block member 16, which is parallel to the XuYu plane (front surface of the substrate P). The excess mist gas Msf that is ejected from the slit aperture portion AP but does not adhere to the front surface of the substrate P is recovered by the recovery unit DN1, which is arranged on the upstream side of the slit aperture portion AP in the substrate P transport direction, and the recovery unit DN2, which is arranged on the downstream side.

The recovery unit DN1 has a structure in which the entirety thereof is surrounded by board materials, is configured to extend in the Yu direction with a length approximately the same as the Yu-direction dimension of the nozzle unit MN, and has the bottom surface thereof provided with a bottom board DN1a arranged to be flush with the bottom surface of the electrode-holding block member 16. A slit-shaped aperture portion DN1b extending in the Yu direction is formed in the region between the bottom board DN1a and the electrode-holding block member 16 in the Xu direction. The internal space of the recovery unit DN1 is depressurized via an exhaust pipe EP1a connected to a vacuum pump. Due to this, the excess mist gas Msf ejected from the slit aperture portion AP of the nozzle unit MN is sucked into the internal space of the recovery unit DN1 from the aperture portion DN1b that has been set to a negative pressure. Inside the internal space of the recovery unit DN1, a filter portion DN1c, which traps the mist in the mist gas Msf travelling toward the exhaust pipe EP1a and passes the gas, is provided at an incline. The mist trapped by the filter portion DN1c is collected (coagulated) and stored in a liquid state on the bottom board DN1a, and is recovered via a drain pipe EP1b connected to a suction pump.

The recovery unit DN2 is arranged symmetrically with the recovery unit DN1 in a manner to sandwich the slit aperture portion AP of the nozzle unit MN and, in the same manner as the recovery unit DN1, is formed by a bottom board DN2a, an aperture portion DN2b, a filter portion DN2c, an exhaust pipe EP2a, and a drain pipe EP2b. The recovery unit DN2 sucks the excess mist gas Msf, which is ejected from the slit aperture portion AP of the nozzle unit MN and flows upstream along the front surface of the substrate P, from the aperture portion DN2b, the gas is sucked in by the exhaust pipe EP2a, and the liquid formed by aggregated mist is recovered via the drain pipe EP2b. The Yu-direction lengths of the aperture portion DN1b of the recovery unit DN1 and the aperture portion DN2b of the recovery unit DN2 are set to be equal to the Yu-direction length of the slit aperture portion AP of the nozzle unit MN.

In the present embodiment, an Xu-direction distance (interval) Xe1, from the center line AXs of the slit aperture portion AP of the nozzle unit MN to the aperture portion DN1b of the recovery unit DN1, and an Xu-direction distance (interval) Xe2, from the center line AXs of the slit aperture portion AP of the nozzle unit MN to the aperture portion DN2b of the recovery unit DN2, are set to be approximately equal, and are set to be as short as possible. These distances (intervals) Xe1 and Xe2 are set to be less than a dimension that is three to five times the Zu-direction interval (gap width) between the bottom surfaces of the bottom boards DN1a and DN2a and the front surface of the substrate P. For example, in a case where the gap width is several millimeters (3 to 6 mm), the distances (intervals) Xe1 and Xe2 are set in a range from 9 to 30 mm. Furthermore, the flow rate (liter/sec) of the gas sucked in at the aperture portion DN1b of the recovery unit DN1 and the flow rate (liter/sec) of the gas sucked in at the aperture portion DN2b of the recovery unit DN2 are each set to be greater than or equal to the flow rate (liter/sec) of the mist gas Msf ejected from the slit aperture portion AP of the nozzle unit MN, preferably to at least 1.5 times the flow rate of the mist gas Msf.

When the suction flow rate for each of the aperture portion DN1b of the recovery unit DN1 and the aperture portion DN2b of the recovery unit DN2 is set in this way, it is possible to restrict the mist gas Msf that is ejected from the slit aperture portion AP of the nozzle unit MN and flows in the Yu direction along the front surface of the substrate P. As shown in FIGS. 1 or 17, the bottom end surface of the nozzle unit MN in the -Zu direction (bottom surface of the electrode-holding block member 16) is arranged at an interval (gap) of approximately several millimeters from the front surface of the substrate P. Therefore, in a case where the recovery unit DN1 and recovery unit DN2 are not present, the mist gas Msf ejected from the slit aperture portion AP spreads in all directions within the XuYu plane and leaks out, and the mist in the mist gas Msf adheres to the locations that this mist gas Msf reaches inside the mist deposition apparatus.

By providing the recovery unit DN1 and recovery unit DN2 such as shown in FIG. 17, the flow of the mist gas Msf ejected from the slit aperture portion AP of the nozzle unit MN can be limited to the Xu direction along the front surface of the substrate P, and almost all of the excess mist gas Msf can be efficiently recovered. Accordingly, no mist gas Msf leaks into the mist deposition apparatus MDE from the mist depositing section 1 formed by the nozzle unit MN, the recovery unit DN1, and the recovery unit DN2, and the frequency of temporarily stopping operation of the apparatus in order to clean the inside of the apparatus can be greatly reduced or eliminated.

### Fifth Modification

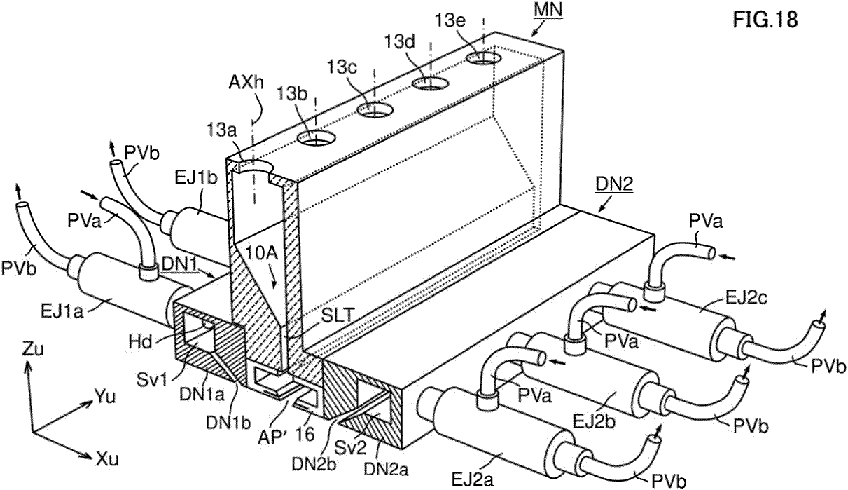

FIG. 18 shows a modification of the mist depositing section 1 of the second embodiment shown in FIG. 17, and is a perspective view represented by a partial cross section obtained by cleaving along a plane parallel to the XuZu plane in the XuYuZu coordinate system. In the present modification, the nozzle unit MN has a structure equivalent to that shown in FIG. 5 above, the mist gas Msf is supplied from each of five inlet ports 13a to 13e, and the Yu-direction flow speed distribution of the mist gas Msf flowing into the slot portion SLT is caused to be uniform by the inclined inner wall surface 10A in the internal space. Furthermore, in the present modification, the electrode-holding block member 16 supporting the pair of electrode rods 15A and 15B (omitted from FIG. 18) for plasma discharge is provided at the -Zu-direction side of the nozzle unit MN. The mist gas Msf that has passed through the slot portion SLT of the nozzle unit MN passes through a slit aperture portion AP′, formed extending in the Yu direction in the -Zu-direction bottom portion of the electrode-holding block member 16, to be sprayed onto the front surface of the substrate P. Each member and structure in FIG. 18 that is the same as in FIG. 17 above is given the same reference numeral.

A block member of the recovery unit DN1 including the bottom board DN1a and the slit-shaped aperture portion DN1b is arranged at the -Xu-direction side of the electrode-holding block member 16 and the nozzle unit MN, and a block member of the recovery unit DN2 including the bottom board DN2a and the slit-shaped aperture portion DN2b is arranged at the +Xu-direction side. The block members of the recovery unit DN1 and the recovery unit DN2 in the present modification are each formed with an overall prismatic shape when viewed in the XuZu plane, and have respective rectangular spaces Sv1 and Sv2 formed therein with cross sections extending in the Yu direction. The slit-shaped aperture portion DN1b is in communication with the space Sv1 via an inclined flow path, and the slit-shaped aperture portion DN2b is in communication with the space Sv2 via an inclined flow path. Furthermore, both Yu-direction end portions of each of the block members of the recovery unit DN1 and recovery unit DN2 are closed off by board members such that the spaces Sv1 and Sv2 and aperture portions DN1b and DN2b are not open.

Furthermore, a plurality of vacuum generators (referred to below as ejectors) EJ1a, EJ1b, etc. for depressurizing the space Sv1 are mounted along the Yu-direction on the -Xu-direction side of the block member of the recovery unit DN1. Each of the ejectors EJ1a, EJ1b, etc. is configured to form a flow path (exhaust port) for discharging pressurized gas (compressed air), supplied via a pipe PVa, toward a pipe PVb to form a depressurized flow path (suction port) created as a result of the Venturi effect or the like due to the above flow path. The exhaust port for generating the reduced vacuum pressure is connected to a hole Hd formed in a -Xu-direction-side wall surface of the block member of the recovery unit DN1. The space Sv1 of the block member of the recovery unit DN1 is depressurized by each of the ejectors EJ1a, EJ1b, etc., and therefore the excess mist gas Msf ejected from the slit aperture portion AP′ of the nozzle unit MN is suctioned from the aperture portion DN1b of the block member of the recovery unit DN1 to be recovered via the pipe PVb of each of the ejectors EJ1a, EJ1b, etc.

Similarly, a plurality of vacuum generators (ejectors) EJ2a, EJ2b, EJ2c, etc. for depressurizing the space Sv2 are mounted along the Yu-direction on the +Xu-direction side of the block member of the recovery unit DN2. Each of the ejectors EJ2a, EJ2b, EJ2c, etc. depressurizes the space Sv2 of the block member of the recovery unit DN2 via an exhaust port that generates vacuum pressure created by pressurized gas (compressed air) supplied from the pipe PVa. Due to this, the excess mist gas Msf ejected from the slit aperture portion AP′ of the nozzle unit MN is suctioned from the aperture portion DN2b of the block member of the recovery unit DN2 to be recovered via the pipe PVb of each of the ejectors EJ2a, EJ2b, and EJ2c.

In the present modification as well, the air volume of the pressurized gas supplied via the pipe PVa to each of the ejectors EJ1a, EJ1b, EJ2a, EJ2b, and EJ2c is set such that the air volume (liter/sec) sucked in by each of the aperture portions DN1b and DN2b of the respective block members of the recovery units DN1 and DN2 is increased to be in a range 1 to 2 times the air volume (liter/sec) of the mist gas Msf ejected from the slit aperture portion AP′ of the nozzle unit MN. For the ejectors EJ1a, EJ1b, EJ2a, EJ2b, and EJ2c, vacuum generators VRL sold by Nihon Pisco Co., Ltd. can be used as a device capable of conveying gas containing granules and powder.

In the present modification, the nozzle unit MN, the electrode-holding block member 16, and the recovery units DN1 and DN2 are all in close contact and are assembled almost integrally, and the bottom surfaces of the bottom boards DN1a and DN2a of the recovery units DN1 and DN2 and the bottom surface of the electrode-holding block member 16 are formed to be in the same plane, parallel to the XuYu plane, without a gap therebetween. Furthermore, as described above, each block member of the nozzle unit MN, the electrode-holding block member 16, and each block member of the recovery units DN1 and DN2 are made of any one of acrylic resin (polymethyl methacrylate: PMMA), fluorine resin (polytetrafluoroethylene: PTFE), thermoplastic polycarbonate, or glass material such as quartz.

By using the vacuum generators (ejectors) such as described above, the excess mist gas Msf suctioned from the aperture portions DN1b and DN2b of the respective recovery units DN1 and DN2 is conveyed to the pipe PVb with almost no pressure loss. The tips of the pipes PVb from each of the ejectors EJ1a, EJ1b, EJ2a, EJ2b, and EJ2c are gathered together into one pipe and connected to a recovery mechanism. A system that recovers, in a particulate state, nanoparticles contained in the mist by removing moisture from the excess mist gas Msf with a freeze dryer is used as the recovery mechanism.

### Sixth Modification

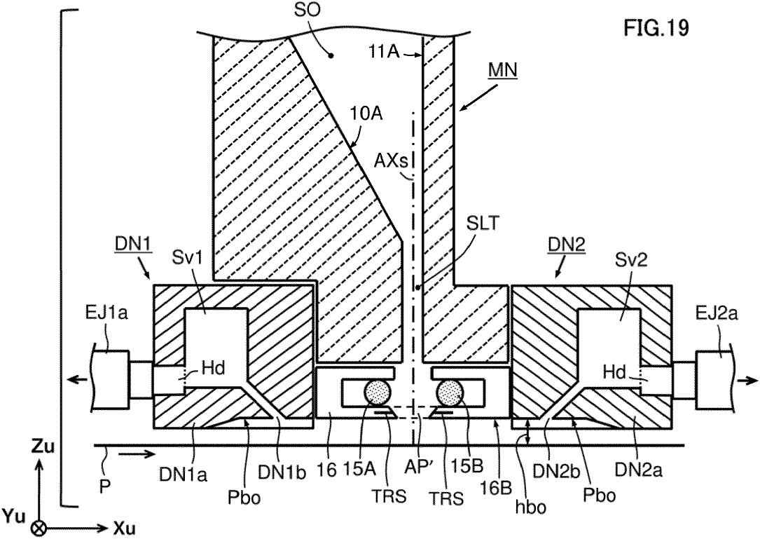

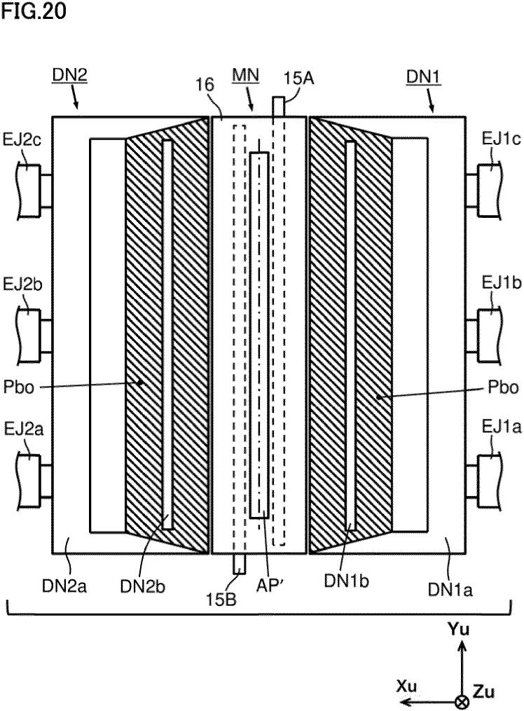

FIG. 19 is a partial cross section showing another modification of the configuration of the mist depositing section 1 of FIG. 18, and each member and structure shown in FIG. 19 that is the same as those in FIG. 18 is given the same reference numeral. In the configuration of FIG. 18, the bottom surfaces of the bottom boards DN1a and DN2a of the respective recovery units DN1 and DN2 are formed to be flush with the bottom surface of the electrode-holding block member 16, but in the configuration of FIG. 19, on the bottom surfaces of the bottom plates DN1a and DN2a of the recovery units DN1 and DN2, a recessed surface Pbo, which is recessed by a slight dimension (approximately several millimeters) from the surrounding area, is formed. FIG. 20 is a view of the bottom surface of the mist depositing section 1 of FIG. 19, seen from the substrate P side.

As shown in FIGS. 19 and 20, the Zu-direction height position of the recessed surface Pbo (diagonal line portion in FIG. 19) of the bottom boards DN1a and DN2a of the respective recovery units DN1 and DN2 is set to be the same as the Zu-direction height position of the flat bottom surface 16B of the electrode-holding block member 16 below the nozzle unit MN. Accordingly, the mist gas Msf ejected from the slit aperture portion AP′ of the electrode-holding block member 16 is stored in the space having an interval hbo (see FIG. 19) sandwiched by the top surface of the substrate P and the recessed surfaces Pbo of the bottom boards DN1a an DN2a, and suctioned through the aperture portions DN1b and DN2b. In the XuYu plane, the surrounding portion (flat surface) of the recessed surfaces Pbo of the bottom surfaces of the bottom boards DN1a and DN2a is set such that the interval (gap) between this surrounding portion and the front surface of the substrate P is less than the interval hbo. Therefore, by utilizing the gas suction pressure (depressurization) caused by the aperture portions DN1b and DN2b, the mist gas Msf stored in the space of the interval hbo is prevented from leaking to the outside from the bottom surface portion of the recovery units DN1 and DN2 (bottom boards DN1a and DN2a).

As shown in FIG. 20, the Yu-dimensions of the slit-shaped aperture portions DN1b and DN2b formed in the respective bottom boards DN1a and DN2a of the recovery units DN1 and DN2 are set to be slightly longer than the Yu-direction dimension of the slit aperture portion AP′ of the bottom surface 16B of the electrode-holding block member 16 (length of the slit aperture portion AP′ of the nozzle unit MN). Furthermore, the interval between the front surface of the substrate P and the surface at both Yu-direction end portions of the slit aperture portion AP′ of the bottom surface 16B of the electrode-holding block member 16 is the interval hbo, but the surfaces at both of these end portions may be provided with exhaust ports that supply suction pressure in order to prevent leaking of the excess mist gas Msf. Furthermore, in FIG. 19, the slit portion TRS for trapping droplets caused by the aggregation of mist is formed in the portion forming the Xu-direction end surface of the slit aperture portion AP′, at a position below (-Zu side) the electrode rods 15A and 15B of the electrode-holding block member 16.

### Seventh Modification

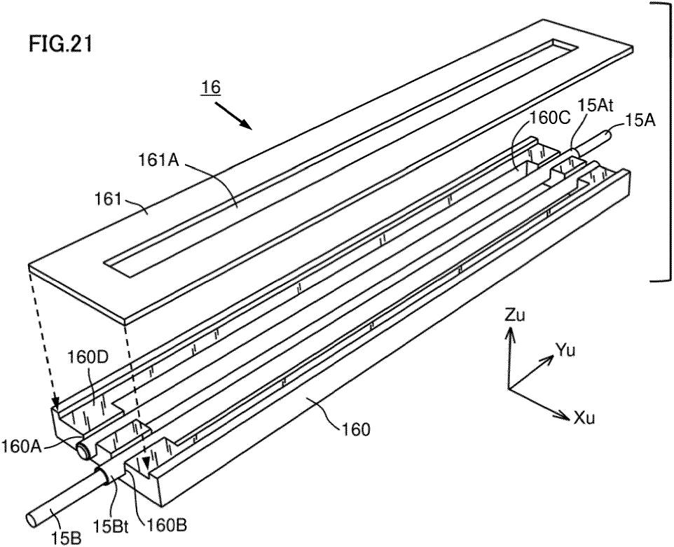

FIG. 21 is a perspective view showing a modification of the structure of the electrode-holding block member 16 shown in each of FIGS. 12 and 17 to 20. In FIG. 21, the orthogonal coordinate system is set to be the same as the XuYuZu coordinate system shown in each of the preceding drawings, and members and arrangements that are the same as those shown in each of the preceding drawings are given the same reference numerals. In FIG. 21, the electrode-holding block member 16 includes a bottom portion support member 160 that supports the two electrode rods 15A and 15B, which extend in the Yu direction, in a state parallel to each other with a prescribed Xu-direction gap therebetween (greater than or equal to the interval Dg of the slit aperture portion AP or AP′). The bottom portion support member 160 is formed by recessed portions 160A and 160B that are notched into a U-shape to hold only the Yu-direction ends of the electrode rods 15A and 15B, a slot-shaped aperture portion 160C that is hollowed out along the Yu-direction length of the slit aperture portion AP (or AP′) such that the electrode rods 15A and 15B are exposed, and a top end surface formed parallel to the XuYu plane in a manner to join with the upper cover board 161D.

The upper cover board 161 includes the slit-shaped aperture portion 161A that is arranged directly below (-Zu direction) the slit aperture portion AP (or AP′) of the nozzle unit MN and formed with approximately the same Yu-direction and Xu-direction dimensions as the slit aperture portion AP (AP′). Furthermore, the outer circumferential surface of each of the electrode rods 15A and 15B that are made of metal (iron, SUS, or the like) are covered by flexible (elastic) tubes 15At and 15Bt made of fluororesin (polytetrafluoroethylene: PTFE). When the mist gas Msf sprayed onto the substrate P is irradiated with plasma, it is necessary to generate stable plasma between the electrode rods 15A and 15B in the Xu direction. Therefore, it is preferable to insert each of the electrode rods 15A and 15B inside a quartz tube having chemical and heat resistance and a high dielectric constant. However, it can be difficult to cause the entire inner wall surface of each quartz glass pipe to be in close contact with the entire outer circumferential surface of the respective electrode rod 15A or 15B.

Therefore, in the present modification, the entire outer circumferential surface of each electrode rod 15A and 15B is covered in close contact by the corresponding flexible PTFE tube 15At or 15Bt that has a relatively high dielectric constant and is chemical and heat resistant. For example, the nominal diameter φf of the inner circumferential surface of each of the tubes 15At and 15Bt is set to be smaller by about several percent to 30% compared to the nominal diameter φe of the outer circumferential surface of each of the electrode rods 15A and 15B, and it is easy to manufacture the electrode rods 15A and 15B covered with an insulator by press-fitting the electrode rods 15A and 15B into the respective tubes 15At and 15Bt. In a case where a single unit of thickness (single layer) for each tube 15At and 15Bt is insufficient, the outer circumferential surfaces of the tubes 15At and 15Bt may be further covered by second tubes made of PTFE. Furthermore, the upper cover board 161 shown in FIG. 21 is not absolutely necessary, and may be omitted.

With the configuration of the electrode rods 15A and 15B for plasma assistance shown in FIGS. 2, 12, 17, 19, and 21 above, it is necessary to irradiate the mist gas Msf ejected from the slit aperture portion AP of the nozzle unit MN with plasma discharge having a uniform distribution in the Yu direction. In order to achieve this, it is necessary to maintain the electrode rods 15A and 15B in a highly parallel state with a constant Xu-direction gap therebetween and to apply high-voltage plasma power with a peak intensity of approximately 20 KV at a relatively high frequency (2 KHz or more) between the electrode rods 15A and 15B such that the plasma is generated stably.

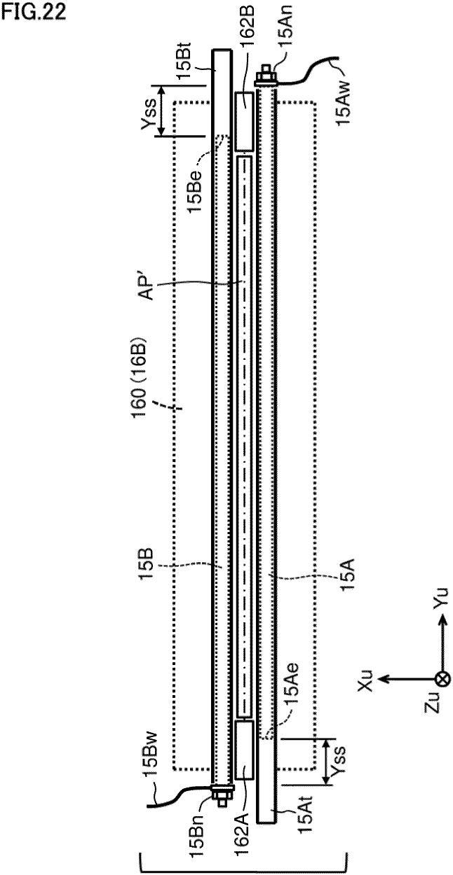

In order to achieve this, it is necessary to realize a high degree of insulation around the electrode rods 15A and 15B to prevent corona discharge and arc discharge in unnecessary portions. FIG. 22 shows a modification of the electrode-holding block member 16 shown in FIGS. 19 and 21 above, viewed from the -Zu side toward the +Zu side. In FIG. 22, a crimp terminal portion 15An, having one cable 15Aw from a high-voltage pulse power supply connected thereto, is provided at the +Yu-direction end portion of the electrode rod 15A arranged on the -Xu side of the slit aperture portion AP′ formed in the bottom portion support member 160 (or bottom surface 16B shown in FIG. 19) of the electrode-holding block member 16. The crimp terminal portion 15An is installed in a manner to protrude from the +Yu-direction end portion of the electrode-holding block member 16 (bottom portion support member 160 or bottom surface 16B). On the other hand, the -Yu-direction end portion 15Ae of the electrode rod 15A is arranged to be positioned farther inward than the -Yu-direction end portion of the electrode-holding block member 16 (bottom portion support member 160 or bottom surface 16B).

Similarly, a crimp terminal portion 15Bn, having the other cable 15Bw from the high-voltage pulse power supply connected thereto, is provided at the -Yu-direction end portion of the electrode rod 15B arranged on the +Xu side of the slit aperture portion AP′ formed in the bottom portion support member 160 (or bottom surface 16B shown in FIG. 19) of the electrode-holding block member 16. The crimp terminal portion 15Bn is installed in a manner to protrude from the -Yu-direction end portion of the electrode-holding block member 16 (bottom portion support member 160 or bottom surface 16B). On the other hand, the +Yu-direction end portion 15Be of the electrode rod 15B is arranged to be positioned farther inward than the +Yu-direction end portion of the electrode-holding block member 16 (bottom portion support member 160 or bottom surface 16B).

As shown in FIG. 22, the crimp terminal portion 15An of the electrode rod 15A and the end portion 15Be of the electrode rod 15B are separated from each other by a distance Yss in the Yu direction, and the crimp terminal portion 15Bn of the electrode rod 15B and the end portion 15Ae of the electrode rod 15A are separated from each other by the distance Yss in the Yu direction. If the distance Yss is sufficiently large and the electrode rods 15A and 15B are each covered along their entire lengths by the tubes 15At and 15Bt, unnecessary arc discharge and the like does not occur between the crimp terminal portion 15An and the end portion 15Be or between the crimp terminal portion 15Bn and the end portion 15Ae, but if the distance Yss is insufficient, there is a concern that unnecessary arc discharge will occur and damage the electrode-holding block member 16.

Therefore, the tube 15At covers the electrode rod 15A over a dimension distance that is the distance Yss longer than the total length from the crimp terminal portion 15An to the end portion 15Ae. In other words, the -Yu-direction end portion of the tube 15At is set to be positioned farther on the -Yu side than the position of the crimp terminal portion 15Bn on the electrode rod 15B side. Similarly, the tube 15Bt covers the electrode rod 15B over a dimension distance that is the distance Yss longer than the total length from the crimp terminal portion 15Bn to the end portion 15Be. In other words, the +Yu-direction end portion of the tube 15Bt is set to be positioned farther on the +Yu side than the position of the crimp terminal portion 15An on the electrode rod 15A side.

Furthermore, although the same structure is disclosed in FIG. 21 above, block members 162A and 162B made of PTFE (insulating body) are provided in the space between, in the Xu direction, the electrode rod 15A covered by the tube 15At and the electrode rod 15B covered by the tube 15Bt, in an area outside of, in the Yu direction, the range in which the mist gas Msf is sprayed at both Yu-direction ends of the slit aperture portion AP′. The -Zu-direction top ends of the block members 162A and 162B are respectively formed with heights slightly lower than the heights of the tubes 15At and 15Bt, the block member 162A is arranged to be positioned laterally beside the end portion 15Ae on the open side of the electrode rod 15A, and the block member 162B is arranged to be positioned laterally beside the end portion 15Be on the open side of the electrode rod 15B.

By providing such block members 162A and 162B, an effect of plasma discharge being strongly concentrated near each of the end portion 15Ae side of the electrode rod 15A and the end portion 15Be side of the electrode rod 15B (occasionally resulting in arc discharge) can be weakened, and it is possible to prevent damage to the tubes 15At and 15Bt. Therefore, the overall durability of the plasma-assist electrode-holding block member 16 is improved. Flexible PTFE is preferable as the material for the tubes 15At and 15Bt, because it is easy to handle in manufacturing, but the outer peripheral surface of each of the electrode rods 15A and 15B may be coated to a predetermined thickness with another material such as a glass epoxy resin containing glass fiber in epoxy resin.

### Eighth Modification

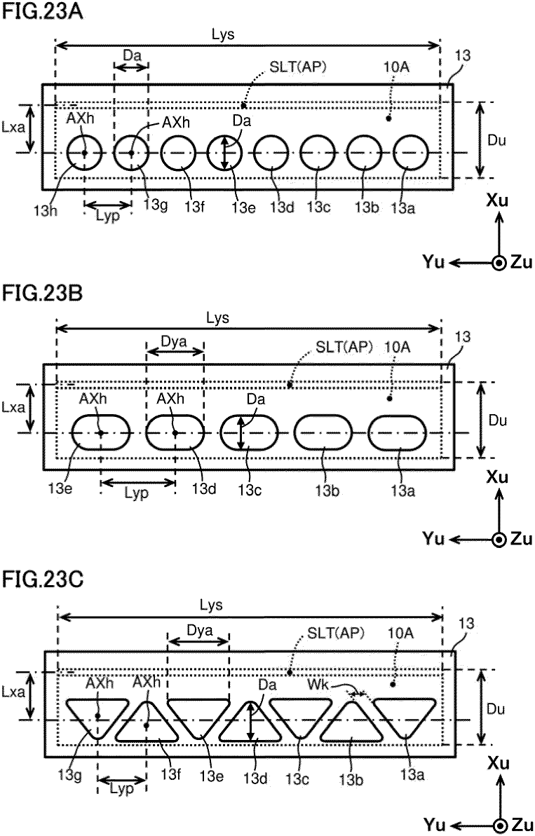

FIGS. 23A to 23C are planar views, seen in the XuYu plane, of several modifications relating to the shape and arrangement of the plurality of inlet ports formed in the block member 13 serving as the ceiling board of the nozzle unit MN. FIG. 23A shows a case where eight circular inlet ports 13a to 13h are arranged along the Yu direction; FIG. 23B shows a case where five inlet ports 13a to 13e, which are elliptical (oval-shaped) with the major axis being in the Yu direction, are arranged along the Yu direction; and FIG. 23C shows a case where seven inlet ports 13a to 13 g, which are shaped as triangles (isosceles triangles) among which one apex angle of each triangle is alternately directed in the +Xu direction and -Xu direction, are arranged along the Yu direction. In FIGS. 23A, 23B, and 23C, the structure of the nozzle unit MN is the same as shown in FIGS. 2 and 3 above, as an example, but a nozzle unit MN having a structure such as shown in FIGS. 10A, 10B, 12, and 14 may be used instead.

In FIG. 23A, as described in FIGS. 2 and 3 above, the center line of each of the inlet ports 13a to 13h is set as AXh, the diameter of each of the inlet ports 13a to 13h is set as Da, the Yu-direction interval between the center points of the inlet ports 13a to 13h is set as Lyp, the Xu-direction interval (width) of the surface on which the inlet ports 13a to 13h are formed on the inner side of the block member 13 is set as Du, and the Xu-direction interval (dimension) from the center line AXh to the slot portion SLT (slit aperture portion AP) is set as Lxa. Furthermore, the Yu-direction dimension of the space SO inside the nozzle unit MN (length of the slot portion SLT) is set as Lys.

As described in FIG. 3 above, the interval (dimension) Lxa and the diameter Da are set to a relationship of Lxa > Da/2, and the eight inlet ports 13a to 13h are set to be positioned with an approximately uniform distribution in the Yu direction within the dimension Lys of the space SO. Furthermore, the ratio Lyp/Da between the diameter Da and the interval Lyp differs according to the flow rate of the mist gas Msf ejected from the inlet ports 13a to 13h, but is set in a range of 1.1 ≥ Lyp/Da ≥ 2.0. Accordingly, the diameter Da may be changed to keep the ratio Lyp/Da within the range or the number of inlet ports 13a to 13h may be decreased or increased, depending on the dimension Lys of the space SO.

In FIG. 23B, with the Xu-direction dimension of each of the oval-shaped inlet ports 13a to 13e being Da and the Yu-direction dimension thereof being Dya, the ratio Dya/Da is set in a range of approximately 1.5 ≥ Dya/Da ≥ 2.0, and the ratio Lyp/Dya between the dimension Dya and the interval Lyp is set in a range of 1.1 ≥ Lyp/Dya ≥ 2.0, in the same manner as in the case of FIG. 23A.

In FIG. 23C, with the position through which the center line AXh of each of the triangular inlet ports 13a to 13g passes being the center point, the center points of the respective inlet ports 13a to 13g are positioned to be shifted slightly from each other in an alternating manner in the Xu direction, in order along the Yu direction. However, the average position of the Xu-direction positions at which the central line AXh of each of the triangular inlet ports 13a to 13 g intersects with the inclined inner wall surface 10A (see FIG. 3) of the nozzle unit MN and the center position of the slot portion SLT in the Xu direction are set to be the interval (dimension) Lxa, in the same manner as in FIGS. 23A and 23B.

In FIG. 23C, with each of the inlet ports 13a to 13g being shaped as an isosceles triangle, the Yu-dimension of the bottom edge opposite the apex angle (other than 60°) being Dya, and the height dimension from the apex angle from the bottom edge being Da, the relationship Dya ≈ Da is established when this apex angle is approximately 53°. Furthermore, in the case of FIG. 23C, with the Yu-direction dimension of the partition wall that partitions each of the introduction ports 13a to 13g in the Yu direction being Wk, the Yu-direction interval (dimension) Lyp between the center lines AXh is set such that Lyp ≈ Wk+(Dya/2). Therefore, by reducing the apex angle and reducing the dimension Wk of the partition wall, it is possible to set the interval (dimension) Lyp and the Yu-direction dimension Dya of each of the inlet ports 13a to 13g to have the relationship Lyp ≤ Dya.

### Third Embodiment

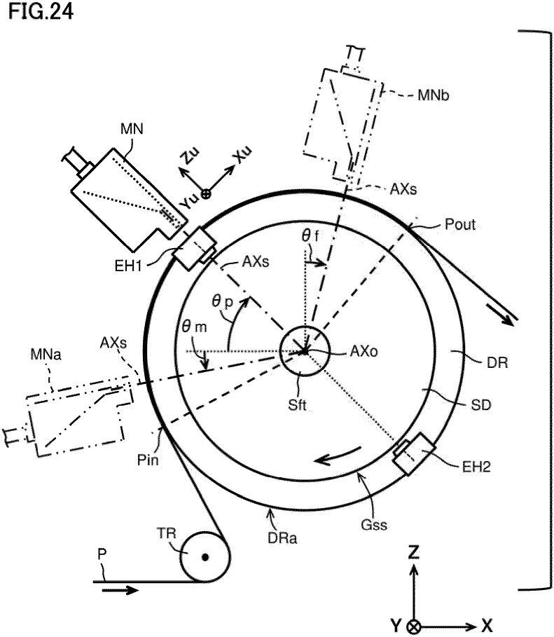

FIG. 24 shows a schematic configuration of a mist deposition apparatus according to a third embodiment, and the XYZ coordinate system and XuYuZu coordinate system are each defined in the same manner as in FIG. 1 above. Furthermore, the nozzle unit MN has the same structure as shown in FIGS. 2 and 3 above. In the present embodiment, a rotating drum DR is provided that rotates at a constant speed while supporting the sheet substrate P curved to have a cylindrical surface shape in the longitudinal direction. The rotating drum DR includes an outer circumferential surface DRa that has a constant radius from a rotational center line Axo arranged to be parallel to the Y axis in the XYZ coordinate system (and the Yu axis in the XuYuZu coordinate system), and a shaft Sft that is connected to a torque shaft of a drive motor or decelerator (gear box), not shown in the drawings, and has the torque around the rotational center line Axo transferred thereto. The shaft Sft is provided protruding from both Y-direction ends of the rotating drum DR, and is axially supported by a support frame (support column) of the apparatus body via a bearing. In the present embodiment, the rotating drum DR that transports the substrate P in the circumferential direction corresponds to the moving mechanism.

Furthermore, in the present embodiment, a tension roller TR for causing the sheet substrate P to be pressed firmly against the outer circumferential surface DRa of the rotating drum DR without experiencing wrinkles is arranged on the upstream side of the rotating drum DR in the substrate P transport direction. When viewed in the XZ plane, the substrate P starts to contact the outer circumferential surface DRa at a position Pin in the circumferential direction on the outer circumferential surface DRa, and separates from the outer circumferential surface DRa at a position Pout. In a case where the drive motor is open-controlled, the rotational speed of the rotating drum DR might exhibit speed unevenness of approximately several percent relative to the target value, due to gear characteristics of the decelerator, capabilities of the bearing, and the like. In the case of mist deposition as well, the transport speed of the substrate P is preferably as uniform as possible, and the speed unevenness is preferably ±0.5% or less, for example.

Therefore, in the present embodiment, a scale disk SD for encoder measurement is mounted coaxially with the shaft Sft, and heads (encoder heads) EH1 and EH2 for reading grid graduations formed with a constant pitch in the circumferential direction along the outer circumferential surface of the scale disk SD are provided. Based on the movement amount of the grid graduations read by each of the encoder heads EH1 and EH2, the movement amount of the outer circumferential surface DRa of the rotating drum DR in the circumferential direction per unit time is measured, and the movement speed of the outer circumferential surface DRa (that is, the substrate P) is sequentially obtained. Then, the speed unevenness is reduced by performing servo control of the drive motor while using the deviation of the actual measured movement speed relative to the target speed value as the feedback information.

The mist gas Msf ejected from the nozzle unit MN is sprayed onto the front surface of the substrate P somewhere between the contact position Pin and the separation position Pout in the circumferential direction of the rotating drum DR. As shown in FIG. 24, the extension line of the center line AXs of the slot portion SLT (slit aperture portion AP) of the nozzle unit MN is arranged to be inclined by the angle θp relative to the XY plane, in a manner to be directed toward the rotational center line Axo (or the shaft Sft) of the rotating drum DR. As described in FIG. 1, the angle θp causes the mist gas Msf to be sprayed onto the front surface of the substrate P inclined by approximately 45° relative to the XY plane, and therefore, in FIG. 24 as well, the XuYuZu coordinate system of the nozzle unit MN is inclined by approximately 45° around the Yu axis in the XYZ coordinate system.

In accordance with such an arrangement of the nozzle unit MN, the encoder head EH1 is arranged with the same orientation as the extension line of the center line AXs of the nozzle unit MN in the circumferential direction of the outer circumferential surface of the scale disk SD, and the encoder head EH2 is arranged on the opposite side of the encoder head EH1 (orientation rotated 180°) in a manner to sandwich the rotational center line Axo. The read position of the grid graduation Gss of the encoder head EH1 is set to have the same position in the circumferential direction of the slit aperture portion AP of the nozzle unit MN, and therefore the ejection position of the mist gas Msf on the substrate P and the measurement position are arranged in a state where there is no Abbe error in the circumferential direction. Essentially, arranging one encoder head EH1 around the scale disk SD is sufficient, but by arranging the second encoder head EH2 at an interval of 180° such as shown in FIG. 24, even if a portion of the leaked mist gas Msf reaches and sticks to the encoder head EH1 resulting in a measurement error, the information concerning the movement amount and movement speed measured by the encoder head EH2 can be immediately used instead, and it is possible to prevent the operation of the apparatus from stopping.

In FIG. 24, a nozzle unit MNa may be used having an arrangement in which the nozzle unit MN is rotated around the rotational center line Axo, and the center line AXs of the slot portion SLT (slit aperture portion AP) is inclined downward by an angle θm (approximately several degrees) relative to the XY plane. In a case where the internal structure of the nozzle unit MNa is the same as in FIGS. 2 and 3 above, when the nozzle unit MNa is arranged such that the center line AXs is positioned farther on the downstream side than the contact position Pin, such as in FIG. 24, the droplets that adhere to the inside of the slot portion SLT, the inclined inner wall surface 10A, or the inner wall surface 11A inside the nozzle unit MNa due to aggregation of the mist are prevented from travelling along the slot portion SLT or slit aperture portion AP and dropping onto the substrate P.

Furthermore, in FIG. 24, a nozzle unit MNb may be used in which the nozzle unit MN is rotated around the rotational center line Axo, the center line AXs of the slot portion SLT (slit aperture portion AP) is inclined toward the downstream side in the transport direction of the substrate P by an angle θf (approximately several degrees) relative to the YZ plane, and the slit aperture portion AP is arranged farther on the upstream side than the separation position Pout. With this arrangement of the nozzle unit MNb, when viewed in the XZ plane, the mist gas Msf ejection position (position of the slit aperture portion AP) becomes the position where the top surface of the substrate P starts to become inclined toward the separation position Pout, and it is possible to transport the substrate P on which the mist has been sprayed held at a constant angle diagonally downward from the separation position Pout immediately thereafter.

In other words, with the arrangement of the nozzle unit MNb shown in FIG. 24, the orientation of the substrate P can be kept in a state of being inclined in one direction from immediately after the film deposition, while the thin liquid film formed on the front surface of the substrate P due to the mist deposition is being dried. Therefore, it is possible to limit the direction in which the thin liquid film attempts to flow due to the effect of gravity to a single direction (downstream side in the case of FIG. 24), so that the thickness distribution of the nanoparticles obtained after drying of the thin film can be made uniform across the entire front surface of the substrate P.

### Ninth Modification

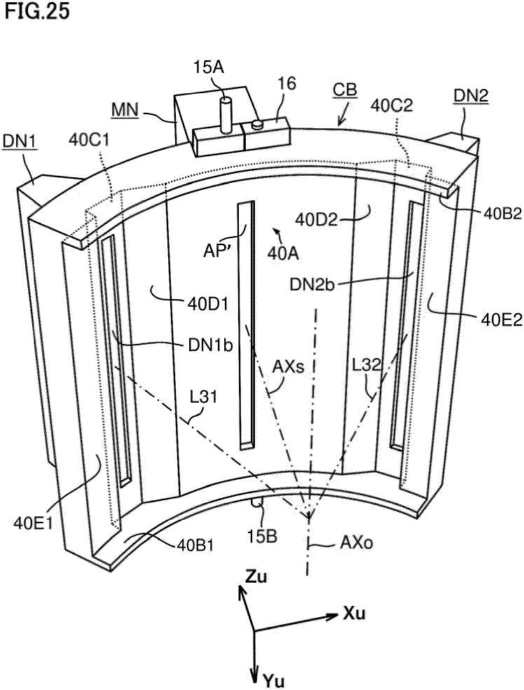

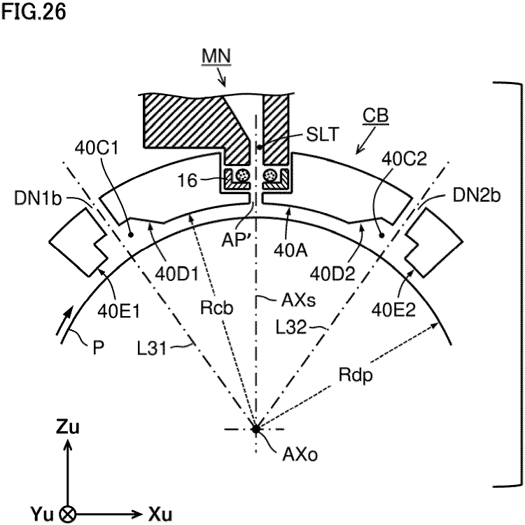

FIG. 25 is a perspective view, seen from the rotating drum DR side, of a modified structure of the cover portion CB assembled together with the nozzle unit MN, the recovery units DN1 and DN2, and the electrode-holding block member 16 when the substrate P is supported by the rotating drum DR such as shown in FIG. 24. Furthermore, FIG. 26 is a cross-sectional view of the cover portion CB of FIG. 25 cleaved by a plane parallel to the XuZu plane. In FIGS. 25 and 26, the XuYuZu coordinate system is the same as the coordinate system defined in each of the preceding drawings, and the internal configuration of the nozzle unit MN here is the same as in FIGS. 2 and 3 above, but may instead be the same as the configuration shown in any of FIGS. 10A, 10B, and 12 to 14.

As shown in FIGS. 25 and 26, the cover portion CB is formed with an overall arc shape curving with a prescribed radius from the rotational center line AXo in accordance with the curvature of the outer circumferential surface DRa (substrate P) of the rotating drum DR, and includes an inner wall surface 40A that curves to face the front surface of the substrate P with a constant interval therebetween in the radial direction and has a Yu-direction width that is greater than the width of the substrate P (or the width of the outer circumferential surface DRa). The radius Rcb of the inner wall surface 40A from the rotational center line AXo is set to be about 5 mm to 15 mm greater than the radius Rdp of the outer circumferential surface DRa of the rotating drum DR (or the substrate P). Furthermore, fan-shaped flange portions 40B1 and 40B2, which face the vicinity of the Yu-direction end portions of the outer circumferential surface DRa of the rotating drum DR with a gap of several millimeters or less (for example, 1 to 3 mm) therebetween, are provided on respective Yu-direction sides of the inner wall surface 40A. The flange portions 40B1 and 40B2 prevent the mist gas Msf, which is ejected from the slit aperture portion AP of the electrode-holding block member 16 formed in the inner wall surface 40A to fill the space between the inner wall surface 40A and the front surface of the substrate P, from leaking in the Yu direction from below the cover portion CB.

Furthermore, rim portions 40E1 and 40E2 extending in the Yu direction to face the front surface of the substrate P with a prescribed gap therebetween are provided at the respective end portion along the circumferential direction of the inner wall surface 40A of the cover portion CB. The surfaces of the rim portions 40E1 and 40E2 facing the substrate P may be cylindrical partially curved surfaces having the same curvature as the radius Rcb of the inner wall surface 40A, and may be set at a position in the radial direction between the radius Rcb and the radius Rdp. Recessed portions 40C1 and 40C2, which are depressed more than the inner wall surface 40A, are formed respectively at the upstream side and downstream side, in the substrate P transport direction, relative to the slit aperture portion AP′ formed in the center portion, in the circumferential direction, of the inner wall surface 40A of the cover portion CB. The recessed portions 40C1 and 40C2 are each formed with a length equal to the width of the inner wall surface 40A in the Yu direction, and are formed to be longer in the circumferential direction than the widths of the slit-shaped aperture portion DN1b of the recovery unit DN1 and the slit-shaped aperture portion DN2b of the recovery unit DN2.

An end portion edge of the recessed portion 40C1 on the slit aperture portion AP′ side is formed as an inclined surface 40D1 that is inclined toward the slit aperture portion AP′ side relative to a plane perpendicular to the inner wall surface 40A (plane extending in the Yu direction and including the rotational center line AXo), and an end portion edge of the recessed portion 40C2 on the slit aperture portion AP′ side is formed as an inclined surface 40D2 that is inclined toward the slit aperture portion AP′ side relative to a plane perpendicular to the inner wall surface 40A (plane extending in the Yu direction and including the rotational center line AXo). With a line extending in the radial direction from the rotational center line AXo and passing through the center of the slit-shaped aperture portion DN1b of the recovery unit DN1 formed inside the recessed portion 40C1 of the inner wall surface 40A being L31 and a line extending in the radial direction from the rotational center line AXo and passing through the center of the slit-shaped aperture portion DN2b of the recovery unit DN2 being L32, the opening angle in the XuZu plane of the line L31 relative to the center line AXs passing through center of the slot portion SLT (center of the slit aperture portion AP′) of the nozzle unit MN and the opening angle in the XuZu plane of the line L32 relative to the center line AXs are set to be approximately equal to each other.

In the present modification as well, the slit aperture portion AP′ that ejects the mist gas Msf and the slit-shaped aperture portions DN1b and DN2b that suction the excess mist gas Msf are each set to have approximately the same length in the Yu direction, but the lengths of the aperture portions DN1b and DN2b may be set to be slightly longer than the slit aperture portion AP′. Furthermore, the flow rate (liter/sec) of the gas sucked in at each of the aperture portion DN1b, DN2b is set to be greater than or equal to the flow rate (liter/sec) of the mist gas Msf ejected from the slit aperture portion AP′ (for example, 1.2 times to 2 times). Accordingly, in the present modification as well, the mist gas Msf ejected from the slit aperture portion AP′ is sprayed onto the front surface of the substrate P directly therebelow, after which the mist gas Msf flows to the upstream side and downstream side in the circumferential direction through the space between the inner wall surface 40A of the cover portion CB and the front surface of the substrate P and reaches the recessed portions 40C1 and 40C2.

The radial-direction dimensions of the spaces in the recessed portions 40C1, 40C2 from the front surface of the substrate P are greater than the radial-dimension direction of the space between the inner wall surface 40A and the substrate P, and therefore the mist gas Msf that reaches the spaces in the recessed portions 40C1 and 40C2 has a flow speed (m/sec) that is lower than the flow speed (m/sec) of the mist gas Msf flowing through the space below the inner wall surface 40A, and is sucked in by each of the aperture portions DN1b and DN2b. By providing such recessed portions 40C1 and 40C2, it is possible to efficiently prevent leakage of excess mist gas Msf from inside the cover portion CB, due to the creation of a strong flow of surrounding atmosphere into the recessed portions 40C1 and 40C2 from the gap between the top surface of the substrate P and each of the rim portions 40E1 and 40E2 of the cover portion CB.

In the modifications described above, when the temperature of the substrate P becomes lower than the temperature of the mist gas Msf, the adhesion rate of the mist onto the substrate P improves, and therefore a temperature adjusting mechanism that lowers the temperature of the outer circumferential surface DRa of the rotating drum DR may be provided inside the rotating drum DR. Furthermore, a temperature adjusting mechanism may be provided that causes the temperature of the cover portion CB (particularly the inner wall surface 40A) to be the same as the temperature of the mist gas Msf. If a sufficient suction force on the excess mist gas Msf can be ensured by each of the aperture portions DN1b and DN2b, the flange portions 40B1 and 40B2 of the cover portion CB shown in FIG. 25 may be omitted. Furthermore, it is not absolutely necessary for the opening angle of the line L31 relative to the center line AXs around the rotational center line AXo shown in FIG. 26 and the opening angle of the line L32 relative to the center line AXs around the rotational center line AXo to be the same. These opening angles are set according to the relationship between the target transport speed of the substrate P and the flow rate of the mist gas Msf ejected from the slit aperture portion AP′.

The following supplementary notes are provided regarding the description of the above embodiments.

### [Note 1]

A mist deposition apparatus that sprays mist gas containing mist in a carrier gas to a front surface of a substrate and deposits nanoparticles contained in the mist onto the front surface of the substrate in a thin film shape, the mist deposition apparatus including a nozzle formed by: a moving mechanism that moves the substrate in a first direction that is along the front surface; a slit aperture portion that is formed in a tip portion, which faces the front surface of the substrate with a prescribed interval therebetween, such that the mist gas is ejected from the tip portion with a distribution extending in a slit shape in a second direction that intersects with the first direction; a first inner wall surface that is connected to one end portion of the slit aperture portion in the first direction, to fill a space that widens in the second direction with the mist gas from the inlet port of the mist gas to the slit aperture portion; and a second inner wall surface that is connected to the other end portion of the slit aperture portion in the first direction and has an interval with respect to the first inner wall surface that becomes narrower from the inlet port toward the slit aperture portion, wherein an angle of intersection between the second inner wall surface and an extension line of a center of an ejection vector of the mist gas ejected from the inlet port is set to be an acute angle.

### [Note 2]

The mist deposition apparatus according to Note 1, wherein, with the extension line of the center of the ejection vector of the mist gas from the inlet port being a center line AXh, a line passing through the center, in the first direction, of the slit aperture portion parallel to the ejection direction of the mist gas from the slit aperture portion being a center line AXs, a dimension of the inlet port in the first direction being Da, and a dimension of the slit aperture portion in the first direction being Dg, an interval Lxa in the first direction from an intersection point between the center line AXh and the second inner wall surface to the center line AXs is set to have a relationship of Lxa > (Da+Dg)/2.

### [Note 3]

The mist deposition apparatus according to Note 2, wherein, with the intersection angle formed by the center line AXh and the second inner wall surface being an angle θa, the angle θa is set in a range of 20° < θa < 40°.

### [Note 4]

The mist deposition apparatus according to Note 2, wherein, with the intersection angle formed by the center line AXh and the second inner wall surface being an angle θa, the angle θa is set in a range of 30°±5°.

### [Note 5]

The mist deposition apparatus according to any one of Notes 2 to 4, wherein the nozzle unit is formed by a first block member that forms the first inner wall surface, a second block member that forms the second inner wall surface, and a third block member that is arranged to connect the first inner wall surface and the second inner wall surface that are separated from each other in the first direction.

### [Note 6]

The mist deposition apparatus according to Note 5, wherein a plurality of the inlet ports are formed in the third block member at prescribed intervals Lyp in the second direction, and a plurality of pipes, connected respectively to the plurality of inlet ports, are further included to individually supply the mist gas that has been generated by a vaporizer.

### [Note 7]

The mist deposition apparatus according to Note 6, wherein each of the plurality of inlet ports is formed as a circle whose diameter is the dimension Da that is set to be less than the interval Lyp.

### [Note 8]

The mist deposition apparatus according to any one of Notes 2 to 4, further comprising a first recovery unit arranged on an upstream side of the slit aperture portion in the transport direction of the substrate and a second recovery unit arranged on the downstream side, in order to suck in an excess portion of the mist that is ejected from the slit aperture portion of the nozzle unit and flows along the front surface of the substrate.

### [Note 9]

The mist deposition apparatus according to Note 8, wherein each of the first and second recovery units includes a slit-shaped aperture portion that is arranged parallel to the slit aperture portion of the nozzle unit and generates a negative pressure that sucks in the excess portion of the mist gas.

### [Note 10]

The mist deposition apparatus according to Note 9, wherein each of the first and second recovery units includes an internal space extending in the second direction and in communication with the slit aperture portion, and a plurality of vacuum generators, which generate vacuum pressure caused by the supply of compressed air to depressurize the internal space, are connected at prescribed intervals in the second direction to the first and second recovery units respectively.

### [Note 11]

The mist deposition apparatus according to Note 9, further comprising an electrode-holding block member that is arranged between the substrate and the slit aperture portion of the nozzle unit and supports a pair of electrode rods for plasma discharge, which are arranged to sandwich, in the first direction, the mist gas ejected from the slit aperture portion, in order to irradiate the mist gas with plasma.

### [Note 12]

The mist deposition apparatus according to Note 11, wherein the electrode-holding block member includes a bottom portion supporting member that has a slot-shaped aperture portion formed therein through which the mist gas passes to the substrate side of the pair of electrode rods, and the first recovery unit and the second recovery unit are arranged to sandwich the electrode-holding block member in close contact in the first direction.

### [Note 13]

The mist deposition apparatus according to Note 12, wherein a surface of the bottom portion support member of the electrode-holding block member facing the substrate and a surface of each of the first and second recovery units in which the slit-shaped aperture is formed facing the substrate are set to be in the same plane parallel to the front surface of the substrate.

1. A deposition apparatus that supplies mist to a front surface of an object and deposits a film made of a material substance containing the mist on the front surface of the object, the deposition apparatus comprising a mist supplying section that includes:
a mist generating section that generates the mist;
an inlet port that introduces the mist generated by the mist generating section into a space; and
a supply port that supplies the mist from the space to the front surface of the object, wherein
the supply port is provided at a different position than the inlet port in a first direction, in a first prescribed plane that includes the supply port where the first direction and a second direction intersect and that has the mist pass therethrough.

2. The deposition apparatus according to claim 1, wherein
the inlet port of the mist supplying section comprises a plurality of inlet ports.

3. The deposition apparatus according to claim 2, wherein
the plurality of inlet ports of the mist supplying section are provided along the second direction.

4. The deposition apparatus according to claim 1, wherein
the mist supplying section includes a first wall surface and a second wall surface that faces the first wall surface, and
the mist supplying section is provided with the inlet port such that the inlet port intersects with the first wall surface, on a condition that the inlet port in a second prescribed plane, through which the mist passes, extends along a third direction orthogonal to the second prescribed plane,.

5. The deposition apparatus according to claim 4, wherein
a width of the supply port is less than a width of the inlet port.

6. The deposition apparatus according to claim 5, wherein
a width of the supply port in the first direction is less than a width of the inlet port in the first direction.

7. The deposition apparatus according to claim 4, wherein
the mist supplying section includes a recovery section that recovers the mist that has adhered to the first wall surface and become a liquid.

8. The deposition apparatus according to claim 4, wherein
the first wall surface has a curved surface.

9. The deposition apparatus according to claim 4, wherein
the second wall surface has a curved surface.

10. The deposition apparatus according to claim 1, comprising:
an object holding section that holds the object in a second prescribed plane, wherein
the mist supplying section is provided at a position facing the object, and supplies the mist to the object from the supply port.

11. The deposition apparatus according to claim 10, wherein
the mist supplying section is provided facing the object holding section, such that the first prescribed plane and the second prescribed plane are parallel to each other.

12. The deposition apparatus according to claim 10, wherein
the object holding section includes a transport section that transports the object; and
the mist supplying section supplies the mist to the object being transported.

13. The deposition apparatus according to claim 12, wherein
the transport section transports the object in a third direction in the second prescribed plane, parallel to the first direction.

14. The deposition apparatus according to claim 13, wherein
the object holding section causes a short side of the object to be arranged in a fourth direction, which is parallel to the second direction and intersects with the third direction in the second prescribed plane.

15. A deposition apparatus that supplies mist contained in a carrier gas to a front surface of an object and deposits a film made of a material substance containing the mist on the front surface of the object, the deposition apparatus including a mist supplying section formed by:
a moving mechanism that moves the object in a first direction that is along the front surface;
a supply port that is formed in a tip portion, which faces the front surface of the object with a prescribed interval therebetween, in a manner that the mist is ejected from the tip portion with a distribution extending in a slit shape in a second direction that intersects with the first direction;
a first wall surface that is connected to one end portion of the supply port in the first direction, to fill a space that widens in the second direction with the mist from the inlet port to the supply port of the mist; and
a second wall surface that is connected to the other end portion of the supply port in the first direction and has an interval with respect to the first wall surface that becomes narrower from the inlet port toward the supply port, wherein
an angle of intersection between the second wall surface and an extension line of a center of an introduction vector of the mist introduced from the inlet port is set to be an acute angle.

16. The deposition apparatus according to claim 1, wherein
the object is a flexible substrate.

17. A conductive film manufacturing method comprising:
a deposition step of using the deposition apparatus according to claim 1 to deposit a conductive film material, which is the material substance, on the object; and
a drying step of drying the object on which the deposition was performed.

18. A mist deposition apparatus comprising:
a mist generating section that generates mist containing a material substance; and
a mist supplying section that includes an inlet port and a supply port, and supplies the mist introduced from the inlet port to a front surface of the substrate from the supply port, wherein
the supply port is provided at a different position than the inlet port in a first direction, which is a direction different from an introduction direction of the mist.

19. The mist deposition apparatus according to claim 18, wherein
a width of the supply port in the first direction is less than a width of the inlet portion in the first direction.

20. A mist deposition apparatus comprising:
a mist generating section that generates mist containing a material substance; and
a mist supplying section that includes an inlet port and a supply port, and supplies the mist introduced from the inlet port to a front surface of the substrate from the supply port, wherein
a width of the supply port in a first direction, which is a different direction than an introduction direction of the mist, is less than a width of the inlet port in the first direction.

21. The mist deposition apparatus according to claim 18, wherein
the supply port includes a plurality of the inlet ports.

22. The mist deposition apparatus according to claim 18, wherein
the mist supplying section includes a space that guides the mist introduced from the inlet port to the supply port.

23. The mist deposition apparatus according to claim 22, comprising:
a recovery section that recovers the mist that has adhered to an inner wall surface in contact with the space and become a liquid.

24. The mist deposition apparatus according to claim 22, wherein
the space is provided between a first wall surface and a second wall surface that faces the first wall surface.

25. The mist deposition apparatus according to claim 24, wherein
at least one of the first wall surface and the second wall surface is provided such that an interval between the first wall surface and the second wall surface becomes narrower from the inlet port toward the supply port.

26. The mist deposition apparatus according to claim 24, comprising:
a recovery section that recovers the mist that has adhered to the first wall surface and become a liquid.

27. The mist deposition apparatus according to claim 24, wherein
the first wall surface has a curved surface.

28. The mist deposition apparatus according to claim 24, wherein
the second wall surface has a curved surface.

29. The mist deposition apparatus according to claim 18, comprising:
a transport section that transports the object, wherein
the mist supplying section supplies the mist to the object being transported.

30. The mist deposition apparatus according to claim 29, wherein
the first direction is a transport direction of the object.

31. A mist deposition apparatus comprising:
a mist generating section that generates mist containing a material substance; and
mist supplying section that includes an inlet port and a supply port, and supplies the mist introduced from the inlet port to a front surface of the substrate from the supply port, wherein
the mist supplying section includes a space that guides the mist introduced from the inlet port to the supply port, the space being provided between the first wall surface and a second wall surface facing the first wall surface; and
at least one of the first wall surface and the second wall surface is provided such that the interval between the first wall surface and the second wall surface becomes narrower from the inlet port toward the supply port.
